(19) United States
(12) Patent Application Publication
(10) Pub. No.: US 2020/0327631 A1
(43) Pub. Date: Oct. 15, 2020

(54) SYSTEM AND METHOD FOR A GLOBAL, MULTI-CRITERIA AND MULTI-STAGE OPTIMIZATION OF PROGRAMS OF WORKS AND BUDGETS IN PUBLIC ROADS ADMINISTRATIONS

(71) Applicant: IOAN DRUTA, Blacksburg, VA (US)

(72) Inventor: IOAN DRUTA, Blacksburg, VA (US)

(21) Appl. No.: 16/381,440

(22) Filed: Apr. 11, 2019

(51) Int. Cl. G06Q 50/26; G06Q 50/08; G06Q 10/06; G06Q 10/04; B60W 40/06; G08G 1/01

(52) U.S. Cl. CPC G06Q 50/26; G06Q 50/08; G06Q 10/0631; B60W 2550/147; B60W 40/06; G08G 1/0137; G06Q 10/04

(57) ABSTRACT

Road network under consideration is divided into homogeneous sections, based on traffic volumes they carry. So, a first optimized list of sections is obtained. Sections are exhaustively surveyed, and their physical and functional-operational condition is evaluated through 14 condition parameters, whose values are brought by conversion into a 0-100 rating scale divided into 6 severity intervals. A Global Serviceability Index is quantified for each homogeneous section and a second optimized list of sections is obtained. Third prioritization is based on combined physical-operational-traffic index values. Thus, optimization at network level produces the final optimized list of sections based on 6 optimization criteria. Optimization at individual homogeneous sections level is a detailed technical analysis based on longitudinal diagrams drawn for each section and each of 14 condition parameters. Last optimization, in relationship to all 14 condition parameters and 6 severity intervals, delivers an optimized program of prescribed remedial works for each homogeneous section, a monetary estimate and an annual optimized budget for entire network.

### DETAILED DESCRIPTION OF THE INVENTION

### General

The object of this invention is to provide a method for the optimization of annual and multiannual programs of works and budgets of public roads administrations on the basis of thorough field surveys, measurements and precise assessment of road's physical and operational deficiencies, failures and damages (230), and on processing, in a certain manner, of the data so obtained, and following several optimization criteria (310). It can be applied to any distinct, well-defined and self-contained public roads network, administered by a single, separate and independent entity; it can be equally applied to a definite fraction of such a network, like a certain category of public roads, the road transportation infrastructure of a certain administrative unit, etc. (100)

The said networks can be constituted of entirely paved roads, and/or can be networks containing wholly or partially unpaved road links. (100)

This detailed description of the process of embodiment of the invention is centered upon a real-like practical numerical example, for demonstrating its applicability. To illustrate the actual reduction to practice of this invention, a sample, pilot road network was established, defined and used, which network, in turn, is composed of distinct road links. (100)

All figures, numbers, orders of magnitude of quantities etc, given in their absolute numerical values, used for the application in practice of this invention are exclusively for exemplification and, hence, any values, data, and information, apparently close to real values of similar quantities are simply incidental and should be considered as such.

The terms specific to the field of this invention and to its description herein have been defined only to the extent needed to ensure maximum intelligibility. Also, this detailed description contains a reasonable amount of information needed for demonstrating its practical applicability. Every effort has been made to eliminate redundancies in terms of text and mathematical elements.

Any consistent and time stable road location reference system can be used. The reference post signs method was used to describe the invention (100). The SI system of weights and measures was used in this description.

### Assessment of Physical (or Technical) and Operational Condition of the Whole Road Network

The initial part of the application of this invention shall be the exhaustive survey of the physical and operational condition of the road network in question for minutely assessing its global “state of health” on the basis of several condition parameters and sub-parameters. (200), (210)

For an appropriate demonstration of the reduction to practice of this invention, and in order to exhaustively survey the whole pilot network, each of its component links was divided into distinct, well defined and homogeneous individual sections. (200)

Criterion for Dividing the Network into Homogeneous Sections

The principle to be considered when the links of the network in question shall be divided into individual homogeneous sections is that the length of these sections be as stable as possible in time, since, upon this segmentation the field surveys, the measurements of condition parameters and sub-parameters shall be carried out.

In order to ensure such homogeneity, the uniform, constant traffic volume along each such section was chosen. The traffic volumes attached to the network's individual links and sections lead automatically to meeting the above criterion (200). The division of the network links into homogeneous sections using the constant traffic volumes criterion is the most stable one, as regards the constancy in time of the length of road sections; it is, at the same time, the most logical from the standpoint of the application of this invention.

This type of division has the slowest dynamics. The extremes of any traffic homogeneous road section are, as a rule, two nodal points; between them there are few or no factors likely to change the traffic volume constancy. Any road link of the network can carry a uniform, constant volume of traffic from the beginning to the end, but, if not, it shall be further divided into 2 or more traffic homogeneous sections. (200)

Table 1 shows the sample network used for numerical exemplification; it was divided as described above (200). This sample network is composed of 9 links. Some of these links carry a uniform amount of traffic from the beginning to the end, e.g. X01A, X072, XPEBW, and consequently are homogeneous links, while others are divided into 2 or more sections, homogeneous in relation to constant traffic volume which they carry; e.g. link X002 is divided into 5 traffic homogeneous sections. The total length of this link is: 5.984 km+10.015 km+7.026 km+26.991 km+24.016 km=74.032 km. All links and sections on which the traffic volume is constant all along their length are given in this table. The links and sections, 23 in all, are sorted here in a descending order of the number of ESALs, or Equivalent Standard Axle Loads that they carry. (200)

ESAL has a specific value in each country, in accordance with specific national regulations; e.g. in the US 1(one) ESAL is 18,000 lb, or 80 kN, per single axle. In Europe 1(one) ESAL is 115 kN, or 11.5 ton, per single axle. ESALs are used in Table 1 exclusively for an initial priority ordering of the sections composing the links of the pilot road network, by way of uniform traffic volumes carried by each of them (200). The ESALs shall actually be used at the end of the multi criteria optimization process, during the actual geometric, capacity and pavement structural design of the works prescribed to be executed.

It comes out from Table 1 that the total number of homogeneous sections is 23, and the maximum number of ESALs, i.e. 4,298, is on section No 1, i.e. the road link X006, the section from km 8.490 to km 13.990, of a length of 5.500 km. The minimum number of standard vehicle axles, that is 1,197 ESALs, is on the link X01B, section No 23 from km 36.889 to km 65.003, of a length of 28.114 km (200). The traffic volumes shown represent the traffic recorded on both directions of flow.

Yet another rationale for choosing the constant traffic volume as a criterion for dividing the links of the network into homogeneous sections is that the road maintenance, rehabilitation and upgrading works are aiming at servicing the traffic. On a road section on which the traffic volume is constant, regardless its magnitude, hence a homogeneous section, constant, uniform serviceability conditions should be ensured for said traffic.

Further in this description, the term homogeneous section shall be used with reference to uniform traffic volumes and be called simply “section”, while the term “link” is one definite route component of the sample network or, in general, of the road network in question.

### Defining Technical (or Physical) and Operational Condition Parameters and Sub-Parameters

In order to prepare an optimized annual program of works and a corresponding optimized budget, the condition of the road network in question should be known beforehand.

For the purpose of assessing the physical and operational condition of the network, and in order to be thoroughly, globally and exhaustively surveyed, the whole road body (not only the pavement structure) of each road section of each network link, as a complex construction entity, shall be broken down into all its self-contained, distinct, and disjunct component parts, from the largest to the smallest ones, in an arborescent manner. The same shall be done for sections' operational functions. (210)

The survey shall be performed section by section, component part by component part, function by function; it is the only way to exhaustively assess the overall condition of the road body along all distinct, individual homogeneous sections that compose the network in question. This shall be done on the basis of a specific methodology, since each of these constituents, either primary, or secondary, or tertiary, etc, undergo their own specific degradations. The survey results, obtained by specific measurements and/or investigations, shall then be backwardly grouped in such a manner that each group characterizes a self-contained, distinct and disjunct part of the road body (210). A condition parameter shall then be attached to such part, which will best characterize the condition, at a certain moment in time, of that particular road body constituent, along a distinct, particular road section. The distinct, individual degradations, specific to a sub part which is part of said group, hence of a parameter, shall be called sub-parameters. (210)

Bridges and tunnels are not included. Culverts are included since they are component elements of the surface water drainage system. (210)

In this manner a suite of technical (or physical) condition parameters shall be constituted which, in their totality, and, after a numerical value shall have been assessed and quantified for each of them, and then aggregated among them by a specific methodology, shall characterize a distinctly defined and self-contained homogeneous section of the network being surveyed. (210), (250)

Thus, a total correspondence between the constituents of the road body and their degradations, and the condition parameters and sub-parameters shall be established (210). By this correspondence it is ensured that absolutely all defects, degradations, distresses, shortcomings, problems etc, found in any of the constitutive parts, or sub-parts, of the body of a homogeneous road section, are incorporated in a condition parameter, or sub-parameter. Consequently, each condition parameter is related to one of the distinct constituents of the road body and incorporates one or more degradations.

Moreover, in addition to its physical constituents, the road has several operational functions, relating in particular to its operation. Specific parameters shall be attached to such road sections' operational functions which shall also be surveyed, assessed and quantified. (210)

The condition parameters shall therefore be divided into two categories: (1) parameters relating directly and strictly to the physical condition of the road body constituents, further called technical condition parameters, and (2) parameters relating to the operational functions of the road, that is those functions likely to serve the users, further called operational condition parameters. (210)

Currently, the other existing systems for the optimization of programs of works of public roads administrations limit themselves to pavement, which is only one of the component parts of the whole road body. Because of that, most of them are called Pavement Management Systems, or PMSs. None of them evaluates exhaustively the global road condition. (210), (230), (250)

### Prioritization of Condition Parameters

Fourteen technical and operational condition parameters were defined as described above, which, altogether, cover all physical constituents of the road body as well as its operational functions. (210)

The 14 condition parameters established are listed here in their logical order of importance, and further substantiated in this description (210):

### 1 Road Surface Distress, I_{sd}

### 2 Drainage System Condition, I_{dsc}

### 3 Bearing Capacity of Road Body, I_{bc}

### 4 Traffic Safety Level, Iₜₛ

### 5 Road Surface Roughness, Iᵣᵣ

### 6 Skid Resistance, Iₛᵣ

### 7 Geometric Adequacy Index, I_{ga}

### 8 Natural Ground Stability Index, I_{ngs}

### 9 Road Body Stability Index, I_{rbs}

### 10 Winter Serviceability Index, I_{ws}

### 11 Level of Service Index, Iₗₛ.

### 12 Environment Protection Index, Iₑₚ

### 13 Quality of Operations Index, I_{qo}

### 14 Quality of Maintenance Index, I_{qm}

The above 14 parameters were so identified and their scope so defined that an exhaustive assessment of the technical and operational condition of the whole road body can be accomplished after their quantification; the scope of all condition parameters put together, exhaustively cover the overall state of “health” of the road as a civil construction. (210)

Not all of the 14 condition parameters are equally perceived by the road users, and some of them, in particular those which cannot be “seen”, such as the bearing capacity, are not perceived at all.

The influence of this ordering is not overwhelming upon the solution to the problem for which this invention was made. It can be any other one. Notwithstanding the above order, the principle that such an order of priority should reflect the way the infrastructure's technical and operational condition is maintained and upgraded, shall be pursued, hence the stage satisfaction of users' needs. The annual programs of works shall be optimized accordingly. Really important is that the 14 condition parameters cover the whole range of degradations which each distinct road constituent can undergo (210). The assessment of the overall condition of the road network in question at a certain moment in time is needed in order to precisely determine what type of degradations exist, and where, i.e. in what constituents of the road body and on what road portions exactly, in order to be able to know what type of works should be prescribed, programmed and executed each year to remedy these shortcomings. (210)

The major reason why the condition assessment is needed is that its results shall be used in optimizing the annual programs of works, in particular in relationship to the technical and operational condition criterion, in order that the right type of work is performed at the right location and at the right time. (230)

### Scale of Values for Condition Parameters

Evaluation of the road condition shall be done on the basis of precise quantitative measurement and magnitude assessment of all degradations in all its constituent parts; the results obtained shall be analyzed by means of a uniform reference system. (220)

For simplifying the network surveying and condition parameters' assessment process, the scale of 0-100 was chosen to bring the values of all and each of the 14 condition parameters, and their respective sub-parameters, to a common denominator interval which ensures constancy in the evaluation process (220). Value 0 (zero) is the lowest limit of the interval, hence it reflects the poorest condition, and value 100 is the uppermost limit. This scale ensures uniformity of measurements, provides a means for comparing the values of condition parameters: the smaller their value the poorer the condition they express (220). A 0-100 scale was adopted due to such reference system being the easiest to be perceived by anyone; this scale coincides with the percentage scale, universally utilized and easy to be comprehended. (220)

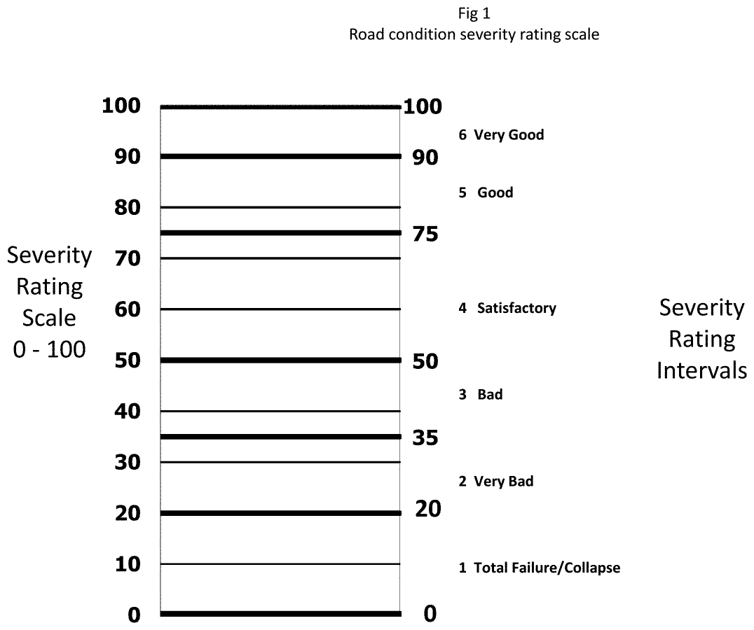

In FIG. 1, a reference system is given, having a value scale of 0-100 points on which the measured and quantified numerical values of the 14 parameters or their sub-parameters shall be plotted. (220)

Condition parameters' severity rating scale, for the characterization of road condition based on condition scores, both for a constitutive part of the road body and for a whole homogeneous section, was divided into 6 severity intervals as follows: 1(0-20), or Collapse; 2(20-35), or Very Bad; 3(35-50), or Bad; 4(50-75), or Satisfactory; 5(75-90), or Good, and 6(90-100), or Very Good. See FIG. 1, Road condition severity rating scale, to which the quantified values of condition parameters shall be related (220). This reference scale shall be used for plotting any quantified values of any deficiency which may occur in any of the road body constituents, hence of any sub-parameters, and, equally, of any condition parameter quantified for a homogeneous road link/section.

Surveying the Network Field Measurements. Data Collection

Each homogeneous section of the road network in question shall be thoroughly surveyed and so shall be the constitutive parts of the road body on each respective section, for the purpose of evaluating its condition at a certain date in time; this means primarily high precision measurements or specialist evaluation of the 14 condition parameters. (230)

The degradations, deficiencies, shortcomings, etc, that occur in each constituent of the road body, shall be identified, surveyed, measured by specific methods, and means, and equipment, and quantified from their severity magnitude standpoint. Once calculated, the severity rating score attached to them shall be expressed in a value situated on a 0-100 scale, and stored. This constitutes the data collection stage. (230)

The costliest component of the application of this invention is the collection of data for which a large variety of methods and equipment can be used. For some parameters, e.g. bearing capacity of the road body, high precision measurement equipment is available which accurately reproduces the actual action of heavy vehicles upon the pavement structure and precisely measures this effect; the same thing does not happen to winter serviceability, level or drainage system condition, and others, for which no measuring equipment exists. Consequently such parameters shall be surveyed by appropriately trained staff, on the basis of detailed and clear-cut technical guidelines, which shall ensure uniformity of results; this kind of survey shall be carried out mainly by visual inspection, manual measurements etc, the main requirement of the condition surveying process being the constancy of data over time. (230)

Measured Values vs. Values on the 0-100 Scale. The surveying equipment currently in use do not record the readings on a 0-100 scale. The conversion of the recorded readings' values to values on a 0-100 rating scale shall be done by means of conversion diagrams proposed and contained in this detailed description. (250)

### Concrete Example of Actual Embodiment of the Invention

For the purpose of demonstrating how this invention can be reduced to practice, a pilot road section was chosen out of the total of 23. It was identified as the section of the link No X001, from km 23+000 through km 35+000, i.e. 12.0 km; again, this is a homogeneous section in relationship to traffic volume which it carries. The AADT for this section, expressed in ESALs of 115 kN, is 1,443. (100), (250)

For the pilot section selected, the way in which each of the 14 condition parameters shall be surveyed, measured and quantified is described and demonstrated hereunder.

### 1 Road Surface Distress, I_{sd}

The component part of the road to which this parameter refers is the carriageway and shoulders surface. The reason for placing this parameter on the first priority is that a degraded road surface is the first thing all motorists sense before anything else. For surveying the carriageway surface condition any distress identification and classification system can be used. The essential is that the said system exhaustively covers all possible degradations susceptible to occur in the road's riding surfaces and shoulders. In line with the above principle, and for demonstration purposes, a series of 15 degradations which regularly occur in asphalt pavements were identified and used: I_{sd1}, potholes, I_{sd2}, raveling, I_{sd3}, shoving, I_{sd4}, polished riding surface, I_{sd5}, fatigue cracking, I_{sd6}, bleeding, I_{sd7}, edge cracking, I_{sd8}, water pumping, I_{sd9}, block cracking, I_{sd10}, rutting, I_{sd11}, patched areas, I_{sd12}, longitudinal cracking, I_{sd13}, transverse cracking, I_{sd14}, reflection cracking, and I_{sd15}, shoulder drop-off. Hereinafter a short description of each of the 15 degradations is given, including the way they shall be surveyed and measured, and their severity level assessed and quantified. (210)

The following process shall be used for assessing the value of this parameter at a certain moment in time, for any homogeneous road section, including the pilot section: (a) the area affected by each of the 15 degradations shall be measured separately and the results shall be expressed in percentage (%) of the total road carriageway or shoulder area for each kilometer of road; thus, for each type of distress, which stands for a partial value of this parameter, hence a surface condition sub-parameter, the value of the respective sub-parameter, in percentages, shall be determined; (b) for each type of distress a longitudinal line chart shall be constructed to reflect, in percentages, the area affected by the respective distress for each kilometer of the road link in question; (c) the numerical value of the 15 distresses, thus the 15 corresponding sub-parameters, all quantified for each kilometer of the homogeneous section in question, and plotted on a 0-100% scale, shall be added up and thus the value of the whole carriageway surface distress parameter, or I_{sd}, is obtained for each kilometer of the said homogeneous section, also on the percentage scale 0-100. (230), (250)

The measurement of the areas affected by these distresses shall be made either manually or automatically by means of equipment specially conceived and designed for this purpose. The means of measurement shall be selected by each road administration or contractor, depending on the availability of equipment and funds allocated therefor, it being not paramount for the application of this invention.

If all the degradations of the roadway along one kilometer of the road section in question, expressed in percentage of the total carriageway area, put together reach 100%, then the value of this parameter on a 0-100 scale is 0 (zero), and vice versa, if there is no surface distress, the severity value is 100, and nothing should be done on that section with reference to surface distress. (220), (230), (250)

Thus, the value of any sub-parameter for a 1 km long road section, converted into scores on a 0-100 scale, is given by the difference of value, in percentages, of the area affected by, e.g. potholes and 100. That is if this percentage is 2%, the value of this sub-parameter is
100−2=98, on a scale of 0-100
   which means on the remaining 98% of the carriageway area there are no potholes. (250)

In general, the value of each of the 15 sub-parameters of the parameter road surface distress, I_{sd}, for an entire homogeneous section shall be calculated as the arithmetic mean of the values of said sub-parameter for each kilometer of the section in question, by the following relation:

$${I}_{s d i} = \frac{{\sum }_{j = 1}^{n} kij}{n}$$

I_{sdi} value of sub-parameter i (i=1-15) which characterizes the whole homogeneous section surveyed, calculated as an arithmetic mean
Kᵢⱼ value of sub-parameter i for the kilometer j
n length in kilometers of the homogeneous section in question

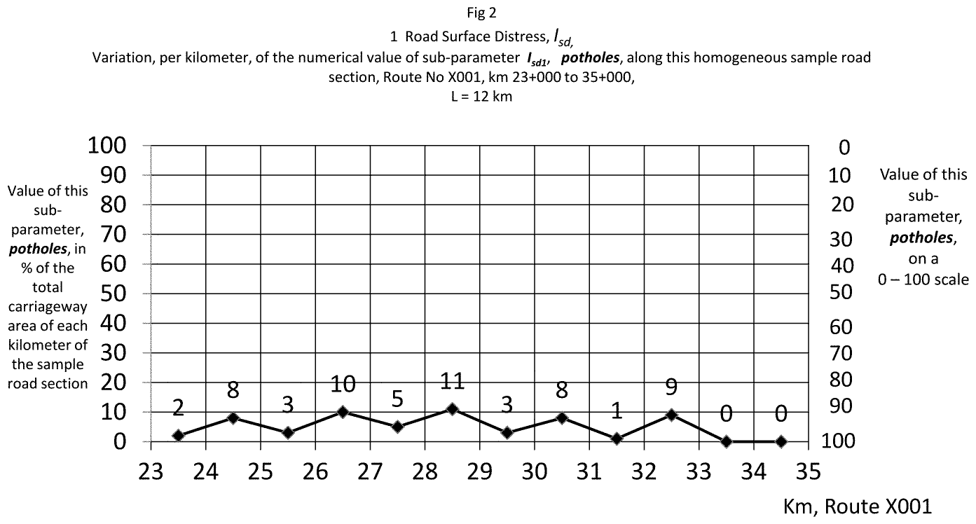

In the numerical example given herein after, on the basis of this relation, the value of I_{sdi} for the pilot homogeneous road section was calculated by using the numeric values employed in the construction of the longitudinal diagrams for each of the 15 sub-parameters. See FIG. 2 to FIG. 16. The results of this calculation were introduced in Table 2, last column. (230), (250)

The length of 1.0 km for a homogeneous sub-section was chosen for ease of calculation. Further in this description, in some of the condition parameters the lengths of homogeneous sub-sections are either 1.0 km or various other orders of magnitude depending on the longitudinal variation of value of the parameter in question.

### For Asphalt Pavements

This invention can be applied to any self-contained network of road links made of any kind of pavements: asphalt, concrete, composite, combined, etc, and/or even non-paved roads. If a certain homogeneous road section of the network in question is made up of sections built of different types of pavement, then it shall be further divided into smaller sections by type of pavement. (100)

For the pilot homogeneous road section, No 16 in column 1 of Table 1, on the link No X001 of the sample network, that is from km 23+000 to km 35+000, hence a total length of 12.0 km, selected as a sample section, the value of all 15 degradations specific to asphalt pavements were quantified.

### Potholes, I_{sd1}.

On each kilometer of each homogeneous section of the road network in question, the areas affected by potholes shall be measured, by approximating them with rectangular shapes. (230), (250)

In the numerical example, FIG. 2 shows the diagram which illustrates the longitudinal variation, per kilometer, of the numerical value of this sub-parameter along the sample homogeneous road section. On the vertical (y) axis the value, in %, of potholes is shown, while on the horizontal (category) axis is the length, in km, of the pilot section.

By using the numerical values of the diagram in FIG. 2, with the relation mentioned above, the value of sub-parameter I_{sd1}, potholes was computed for this sample road section as follows:

$${I}_{sd 1} = \frac{2 + 8 + 3 + 10 + 5 + 11 + 3 + 8 + 1 + 9 + 0 + 0}{12} = \frac{60}{12} = 5.00$$

An average value, I_{sd1}=5.0%, resulted for this sample road section, meaning that, globally, 5% of the carriageway area of this sample section is affected by potholes. On a 0-100 scale this corresponds to a mean value of 95.0, for this sub-parameter. These numbers were introduced in the Table 2. See column 14. (250)

The numerical values plotted on diagram in FIG. 2, i.e. 2, 8, 10, etc, were placed in the middle of each 1.0 km interval, and characterize the whole respective kilometer.

### Raveling, I_{sd2}.

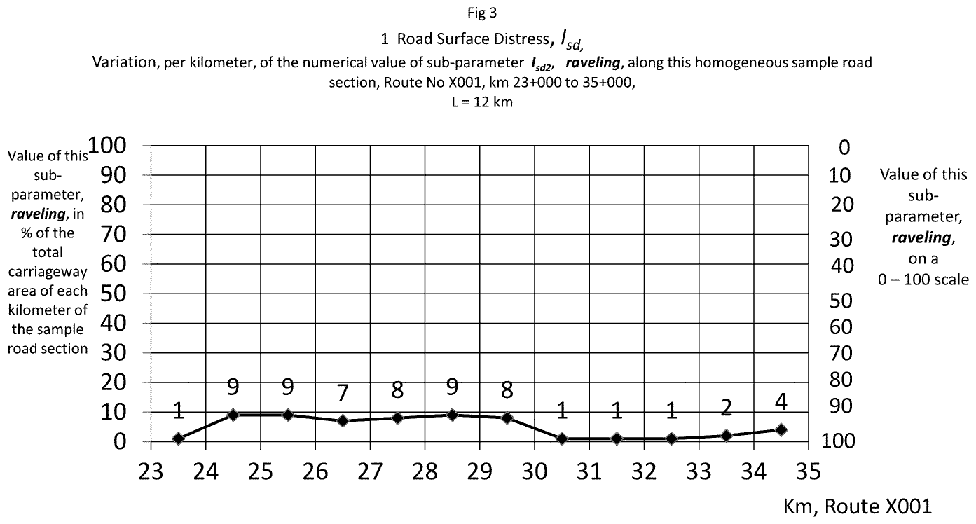

In each kilometer of each homogeneous section of the road network in question, the areas affected by raveling shall be measured by approximating them with rectangular shapes. In the numerical example the longitudinal diagram which illustrates the variation per kilometer of this sub-parameter along the sample homogeneous road section is shown in FIG. 3. (230), (250)

By using the numerical values of the diagram in FIG. 3 the value of I_{sd2}, raveling, was computed as follows:

$${I}_{sd 2} = \frac{1 + 9 + 9 + 7 + 8 + 9 + 8 + 1 + 1 + 1 + 2 + 4}{12} = \frac{60}{12} = 5.00$$

An average value, I_{sd2}=5.0%, resulted for this sample section, meaning that, globally, 5% of the carriageway area of this sample section is affected by raveling. On a 0-100 scale this corresponds to a mean value of 95.0 for this sub-parameter. These numbers were introduced in Table 2. See column 14. (250)

### Shoving, I_{sd3}.

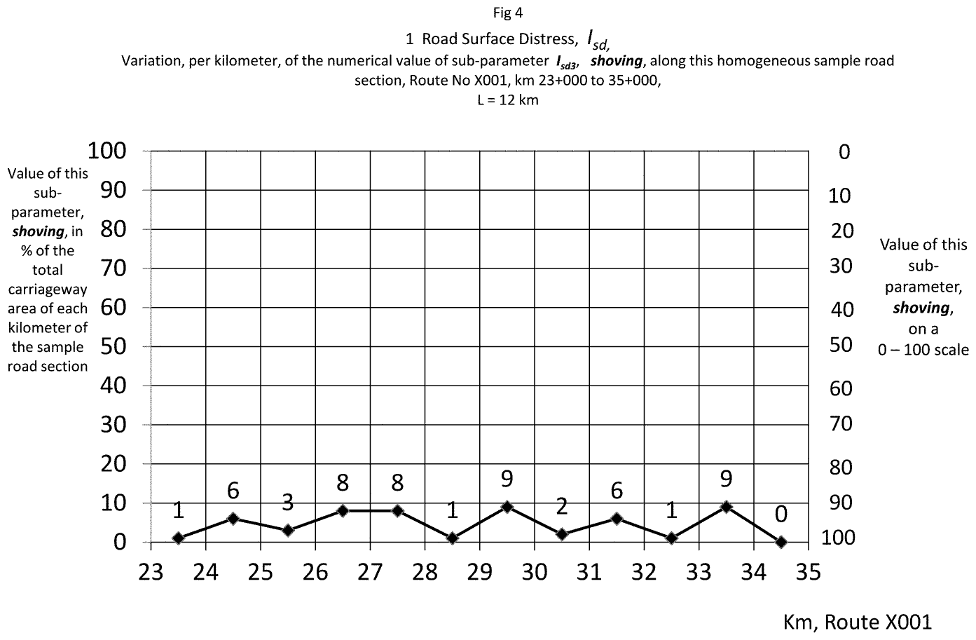

On each kilometer of each section of the road network in question the areas affected by shoving shall be measured by approximating them with rectangular shapes. In the numerical example the longitudinal diagram which illustrates the variation of the value of shoving along the sample homogeneous road section is given in FIG. 4. (230), (250)

By using the numeric values of the diagram shown in FIG. 4, the value of I_{sd3}, shoving, was calculated as follows:

$${I}_{s d 3} = \frac{1 + 6 + 3 + 8 + 8 + 1 + 9 + 2 + 6 + 1 + 9 + 0}{12} = \frac{54}{12} = 4.50 \%$$

An average value, I_{sd3}=4.50%, resulted for this sample road section, meaning that, globally, 4.5% of the carriageway area of this sample section is affected by shoving, corresponding to an average value of 95.50 on a 0-100 scale. See Table 2, column 14. (250)

### Polished Riding Surface, I_{sd4}.

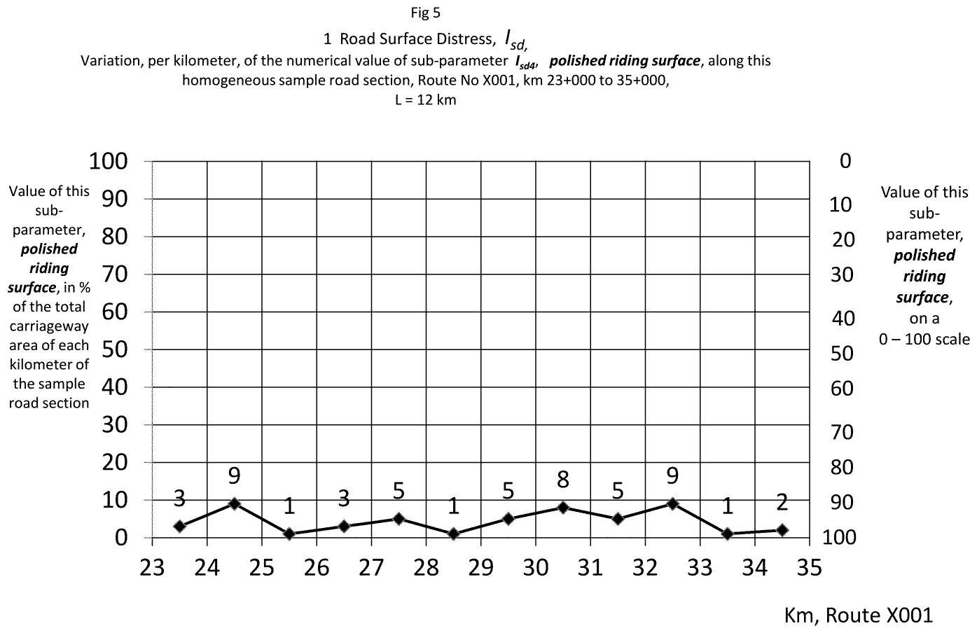

On each kilometer of each section of the road network in question the areas affected by polished riding surface shall be measured by approximating them with rectangular shapes. In the numerical example the diagram which illustrates the variation per kilometer of the value of I_{sd4}, polished riding surface, along the sample homogeneous road section is given in FIG. 5. (230), (250)

By using the numeric values from the diagram in FIG. 5, the value of I_{sd4}, polished riding surface, was calculated as follows:

$${I}_{s d 4} = \frac{3 + 9 + 1 + 3 + 5 + 1 + 5 + 8 + 5 + 9 + 1 + 2}{12} = \frac{52}{12} = 4.33 \%$$

A mean value, I_{sd4}=4.33%, resulted for this sample road section, meaning that, globally, 4.33% of the carriageway area of this sample section is affected by polished riding surface, corresponding to a mean value of 95.67 on a 0-100 scale. See Table 2, column 14. (250)

### Fatigue Cracking, I_{sd5}.

In each kilometer of each section of the road network in question the individual areas affected by fatigue cracking shall be measured; to ease the measurement, the affected portions shall be approximated to a rectangular shape, which will circumscribe the affected area, 10 cm (0.10 m) wide x (times) the total measured length of cracks. All the measured areas in each kilometer shall be added together; then, the total area obtained for the respective kilometer, shall be related to the total carriageway area of said kilometer, thus establishing the percentage affected by fatigue cracking. (230), (250)

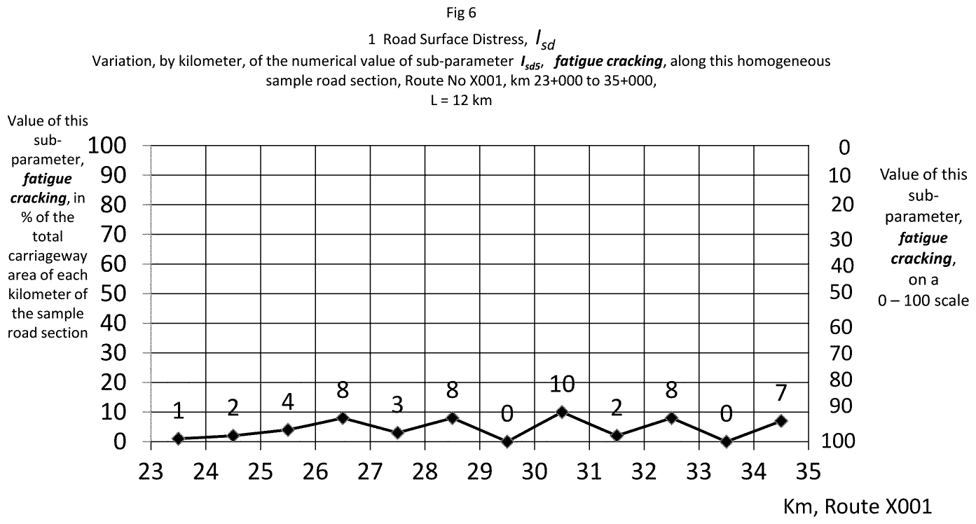

In the numerical example the longitudinal line chart illustrating the variation of the value of I_{sd5}, fatigue cracking, along the sample road section was constructed by plotting the values of this sub-parameter, quantified for each km separately, and shown in FIG. 6.

By using the numerical values from the diagram in FIG. 6, the arithmetic mean value of I_{sd5}, fatigue cracking, was calculated as follows:

$${I}_{s d 5 = \frac{1 + 2 + 4 + 8 + 3 + 8 + 0 + 10 + 2 + 8 + 0 + 7}{12} = \frac{53}{12} = 4.42 \%}$$

A mean value, I_{sd5}=4.42%, resulted for this sample road section, meaning that, globally, 4.42% of the carriageway area of this section is affected by fatigue cracking, corresponding to a mean value of the fatigue cracks of 95.58 on a 0-100 scale. See Table 2, column 14. (250)

### Bleeding, I_{sd6}.

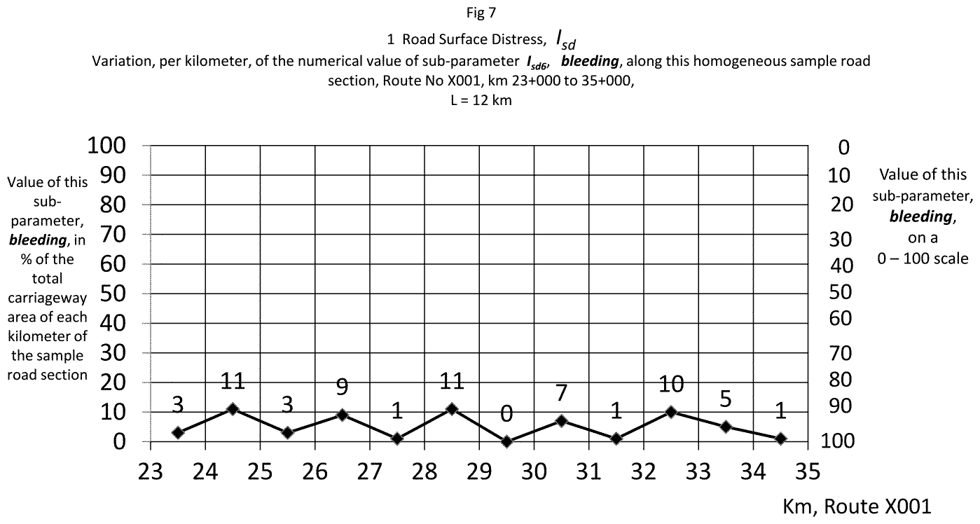

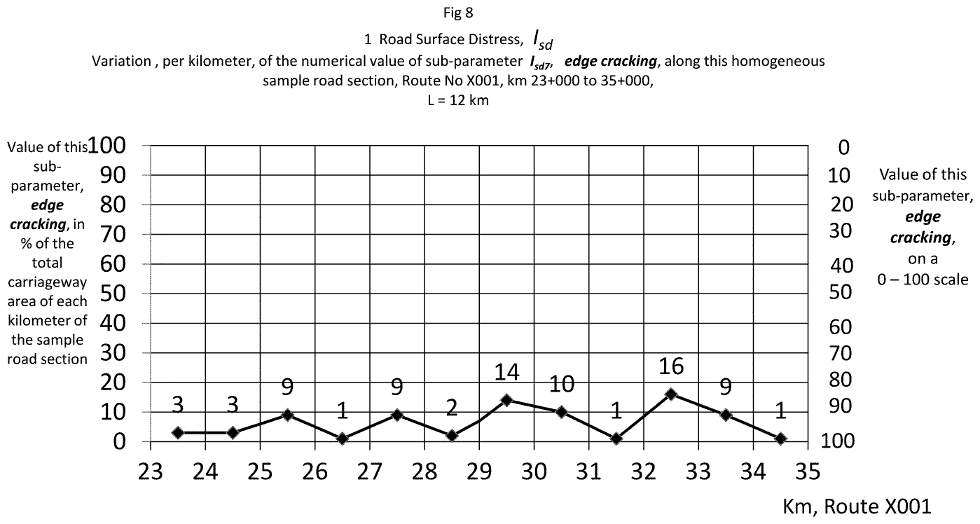

On each kilometer of each section of the road network in question, the areas affected by bitumen bleeding shall be measured by approximating them with rectangular shapes. In the numerical example the diagram which illustrates the variation of the value of bleeding along the sample homogeneous road section is given in FIG. 7. (230), (250)

By using the numeric values from the diagram in FIG. 7, the area affected by I_{sd6}, bitumen bleeding, was calculated as follows:

$${I}_{s d 6} = \frac{3 + 11 + 3 + 9 + 1 + 11 + 0 + 7 + 1 + 10 + 5 + 1}{12} = \frac{62}{12} = 5.17 \%$$

A mean value of I_{sd6}=5.17% resulted for this sample road section, meaning that, globally, 5.17% of the carriageway area of this sample section is affected by bleeding, corresponding to a mean value of bleeding of 94.83 on a 0-100 scale. See Table 2, column 14. (250)

### Edge Cracking, I_{sd7}.

On each kilometer of each section of the road network in question, areas affected by edge cracking shall be measured. To ease the measurement, the affected portions shall be approximated to a rectangular shape, which will circumscribe the affected area, 10 cm (0.10 m) wide x (times) the total measured length of cracks. All the measured areas in each kilometer shall be added together; then, the total area obtained for the respective kilometer, shall be related to the total carriageway area of said kilometer, thus establishing the percentage affected by edge cracking. (230), (250)

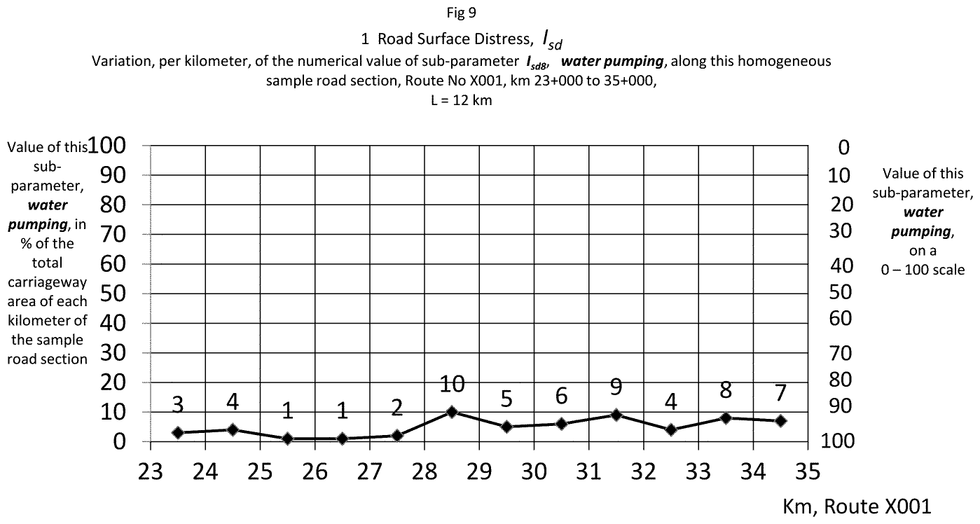

In the numerical example the diagram which illustrates the variation of the value of this sub-parameter along the sample road section was constructed by plotting the values of edge cracking, quantified for each kilometer, and shown in FIG. 8.

By using the numerical values from the diagram in FIG. 8, the area affected by edge cracking, I_{sd7}, was calculated as the arithmetic mean of its values for each kilometer as follows:

$${I}_{s d 7} = \frac{3 + 3 + 9 + 1 + 9 + 2 + 14 + 10 + 1 + 16 + 9 + 1}{12} = \frac{78}{12} = 6.5 \%$$

A mean value, I_{sd7}=6.5%, resulted for this sample road section, meaning that, globally, 6.5% of the carriageway area of this section is affected by edge cracking, corresponding to a mean value of 93.5 on a 0-100 scale. See Table 2, column 14. (250)

### Water Pumping, I_{sd8}.

On each kilometer of each component section of the network in question, the areas affected by water pumping shall be measured by approximating them with rectangular shapes. In the numerical example the diagram which illustrates the variation of the value of this sub-parameter along the homogeneous sample road section was constructed by plotting the numerical values of water pumping quantified for each kilometer, and shown in FIG. 9. (230), (250)

By using the numerical values from the diagram in FIG. 9, the area affected by I_{sd8}, water pumping, was calculated as the arithmetic mean of its values for each kilometer, as follows:

$${I}_{s d 8} = \frac{3 + 4 + 1 + 1 + 2 + 10 + 5 + 6 + 9 + 4 + 8 + 7}{12} = \frac{60}{12} = 5.0 \%$$

A mean value, I_{sd8}=5.0%, resulted for this sample road section, meaning that, globally, 5.0% of the carriageway area of the section is affected by water pumping, corresponding to a mean value of water pumping of 95.0 on a 0-100 scale. See Table 2, column 14. (250)

### Block Cracking, I_{sd9}.

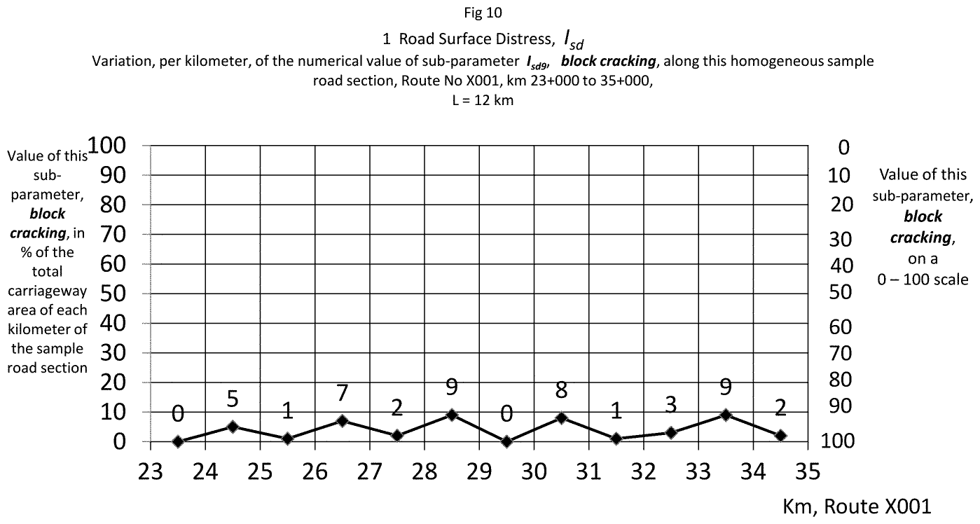

On each kilometer of each road section in question, the areas affected by block cracking shall be measured by approximating them with rectangular shapes. In the numerical example the longitudinal line chart which illustrates the variation of the value of this sub-parameter, block cracking, along this sample road section was constructed by plotting the values for block cracking, quantified for each kilometer, as in FIG. 10. (230), (250)

By using the numerical values from the diagram in FIG. 10, the mean value of this sub-parameter, I_{sd9}, block cracking, for the whole sample section was calculated as follows:

$${I}_{s d 9} = \frac{0 + 5 + 1 + 7 + 2 + 9 + 0 + 8 + 1 + 3 + 9 + 2}{12} = \frac{47}{12} = 3.92 \%$$

A mean value, I_{sd9}=3.92%, resulted for this sample road section, meaning that, globally, 3.92% of the carriageway area of this sample section is affected by block cracking, corresponding to a mean value of 96.08 on a 0-100 scale. See Table 2, column 14. (250)

### Rutting, I_{sd10}.

On each kilometer of each road section of the network in question, the areas affected by rutting shall be measured by approximating them with rectangular shapes, the length being the total length of the section affected by rutting, the width being the average width of the ruts. (230), (250)

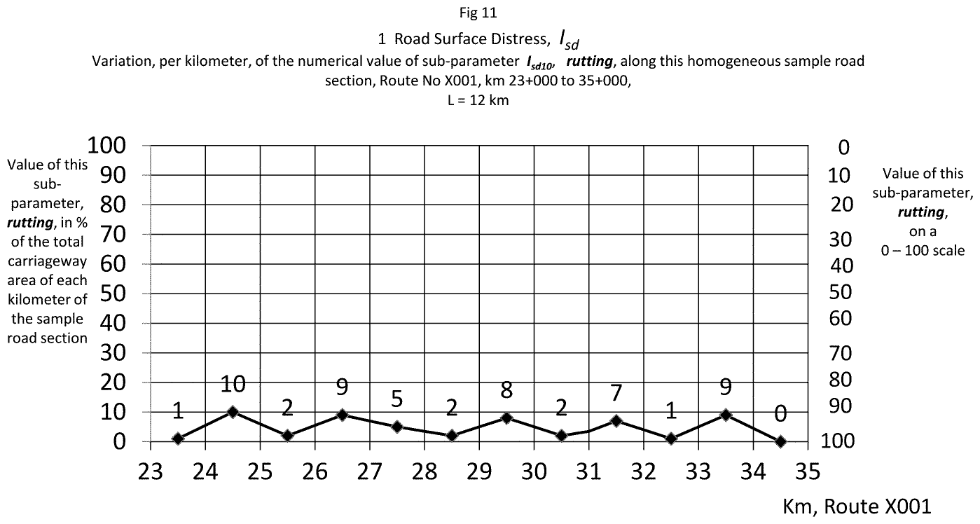

In the numerical example the diagram that illustrates the variation of the value of rutting along the sample homogeneous road section was constructed by plotting the values for rutting, quantified for each kilometer, as in FIG. 11.

By using the numeric values from the diagram in FIG. 11, the mean value of I_{sd10}, rutting, was calculated for the whole sample section, as follows:

$${I}_{s d 10} = \frac{1 + 10 + 2 + 9 + 5 + 2 + 8 + 2 + 7 + 1 + 9 + 0}{12} = \frac{56}{12} = 4.67 \%$$

A mean value, I_{sd10}=4.67%, resulted for this sample road section, meaning that, globally, 4.67% of the carriageway area of this sample section is affected by rutting, corresponding to a mean value of the rutting of 95.33 on a 0-100 scale. See Table 2, column 14. (250)

### Patched Areas, I_{sd11}.

On each kilometer of each section of the road network in question, the damaged and repaired areas shall be measured by approximating them with rectangular shapes. (230), (250)

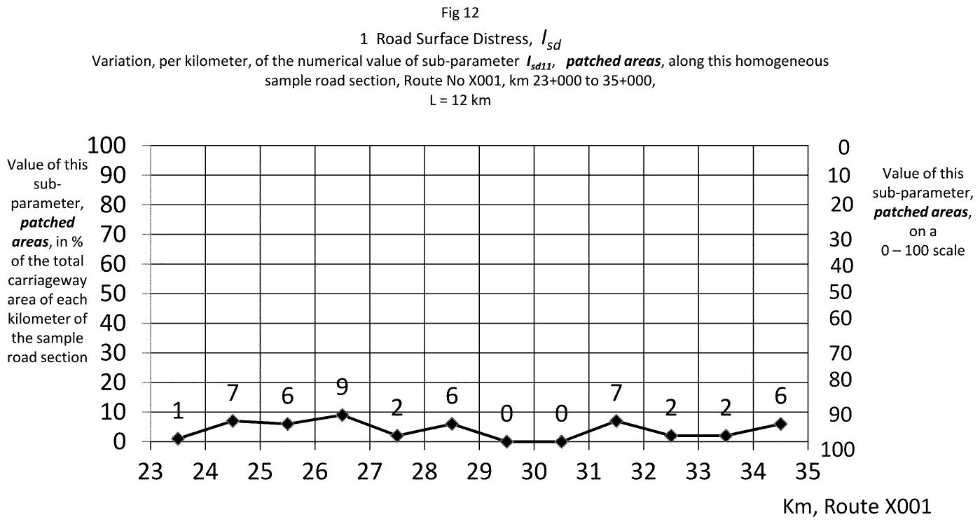

In the numerical example the longitudinal diagram illustrating the variation of values of this sub-parameter, patched areas, along the homogeneous section was constructed and shown in FIG. 12.

By using the numerical values from the diagram in FIG. 12, the mean value of I_{sd11}, for the whole sample section was calculated as follows:

$${I}_{s d 11} = \frac{1 + 7 + 6 + 9 + 2 + 6 + 0 + 0 + 7 + 2 + 2 + 6}{12} = \frac{48}{12} = 4.0 \%$$

A mean value, I_{sd11}=4.0%, resulted for this sample homogeneous road section, meaning that, globally, 4.0% of the carriageway area of this sample section is affected by patched areas, corresponding to a mean value of 96.0 on a 0-100 scale. See Table 2, column 14. (250)

### Longitudinal Cracking, I_{sd12}.

On each kilometer of each section of the road network in question, the total length of every longitudinal crack shall be measured; on portions where there are several such parallel cracks, their length shall be measured separately. The length of quasi-longitudinal cracks, i.e. oblique at an angle of 0-45° in relationship to the road axis, shall also be measured. The affected portions shall be approximated to a rectangular shape, which will circumscribe the affected area, 10 cm (0.10 m) wide x (times) the total measured length of cracks. All the measured areas in each kilometer shall be added together; then, the total area obtained for the respective kilometer, shall be related to the total carriageway area of said kilometer, thus establishing the percentage affected by longitudinal cracking. (230), (250)

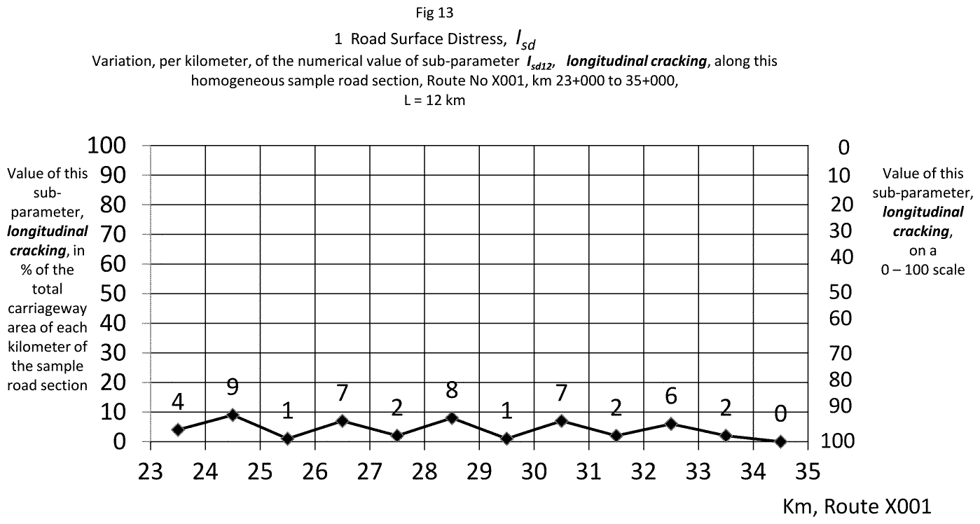

In the numerical example the longitudinal diagram illustrating the variation of quantified values of this sub-parameter along the sample road section was constructed and shown in FIG. 13.

Using the numerical values from the diagram in FIG. 13, the mean value of I_{sd12}, longitudinal cracking, for the whole sample section, was calculated as follows:

$${I}_{s d 12} = \frac{4 + 9 + 1 + 7 + 2 + 8 + 1 + 7 + 2 + 6 + 2 + 0}{12} = \frac{49}{12} = 4.08 \%$$

A mean arithmetic value, I_{sd12}=4.08%, resulted for this sample road section, meaning that, globally, 4.08% of the carriageway area of this sample section is affected by longitudinal cracking, corresponding to a mean value of 95.92 on a scale of 0-100. See Table 2, column 14. (250)

### Transverse Cracking, I_{sd13}.

These cracks are predominantly perpendicular to the road axis, but different from reflection cracks. On each kilometer of each homogeneous section of the road network in question the total length of every transverse crack shall be measured individually. The length of quasi-transverse cracks, i.e. oblique at an angle of 45° to 90° in relationship to the road axis shall also be measured. Other cracks, i.e. at an angle of 0° to 45° are considered longitudinal cracks. The affected portions shall be approximated to a rectangular shape, which will circumscribe the affected area, 10 cm (0.10 m) wide x (times) the total measured length of cracks. All the measured areas in each kilometer shall be added together; then, the total area obtained for the respective kilometer, shall be related to the total roadway area of said kilometer, thus establishing the percentage affected by transverse cracking. (230), (250)

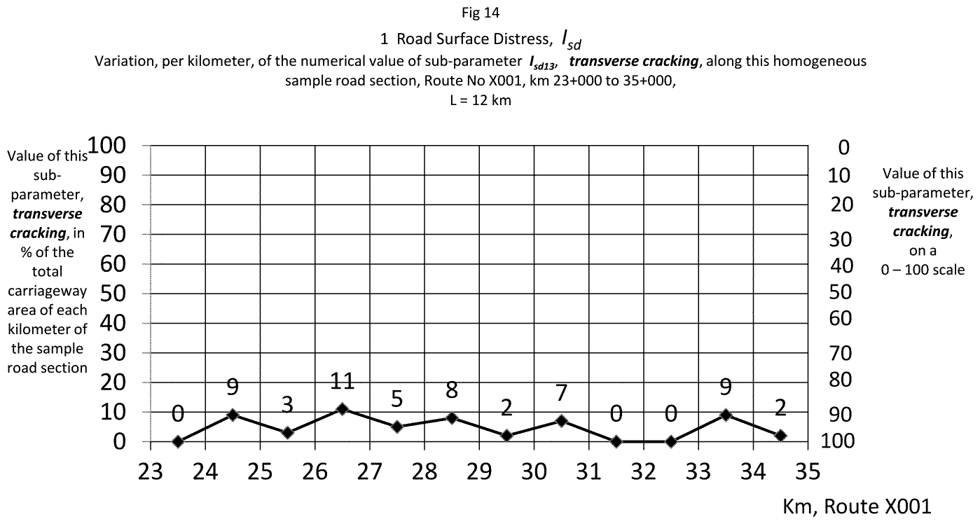

In the numerical example the longitudinal diagram illustrating the variation of this sub-parameter along the sample road section was constructed as in FIG. 14.

By using numerical values from FIG. 14, the mean value of I_{sd13}, transverse cracking, for the whole sample section was calculated as follows:

$${I}_{sd 13 = \frac{0 + 9 + 3 + 11 + 5 + 8 + 2 + 7 + 0 + 0 + 9 + 2}{12} = \frac{56}{12} = 4.67 \%}$$

An arithmetic mean value, I_{sd13}=4.67%, resulted for this sample road section, meaning that, globally, 4.67% of the carriageway area of this sample section is affected by transverse cracking, corresponding to a mean value of 95.33 on a 0-100 scale. See Table 2, column 14. (250)

### Reflection Cracking, I_{sd14}.

These are cracks which occur in asphalt pavement layers built over existing rigid pavements. On each kilometer of each homogeneous section of the road network in question the total length of each reflection crack shall be measured. On portions where several such cracks exist, they shall be measured separately. The cross, oblique, and longitudinal cracks shall be equally taken into consideration. The affected portions shall be approximated to a rectangular shape, which will circumscribe the affected area, 10 cm (0.10 m) wide x (times) the total measured length of cracks. All the measured areas in each kilometer shall be added together; then, the total area obtained for the respective kilometer, shall be related to the total roadway area of that kilometer, thus establishing the percentage affected by reflection cracking. (230), (250)

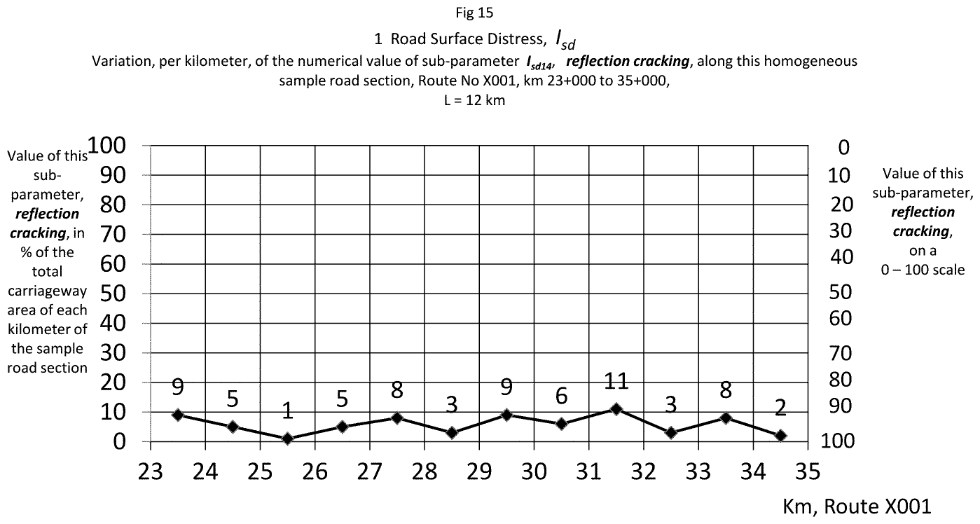

In the numerical example the longitudinal diagram illustrating the variation of this sub-parameter along the sample road section was constructed as in FIG. 15.

By using numerical values from the diagram in FIG. 15, the value of I_{sd14}, was calculated as follows:

$${l}_{s d 14} = \frac{9 + 5 + 1 + 5 + 8 + 3 + 9 + 6 + 11 + 3 + 8 + 2}{12} = \frac{70}{12} = 5$$

An arithmetic mean value, I_{sd14}=5.83%, resulted for this sample road section, meaning that, globally, 5.83% of the carriageway area of this sample section is affected by reflection cracking, corresponding to a mean value of 94.07 on a 0-100 scale. See Table 2, column 14. (250)

### Lane-to-Shoulder Drop-Off: I_{Sd15}

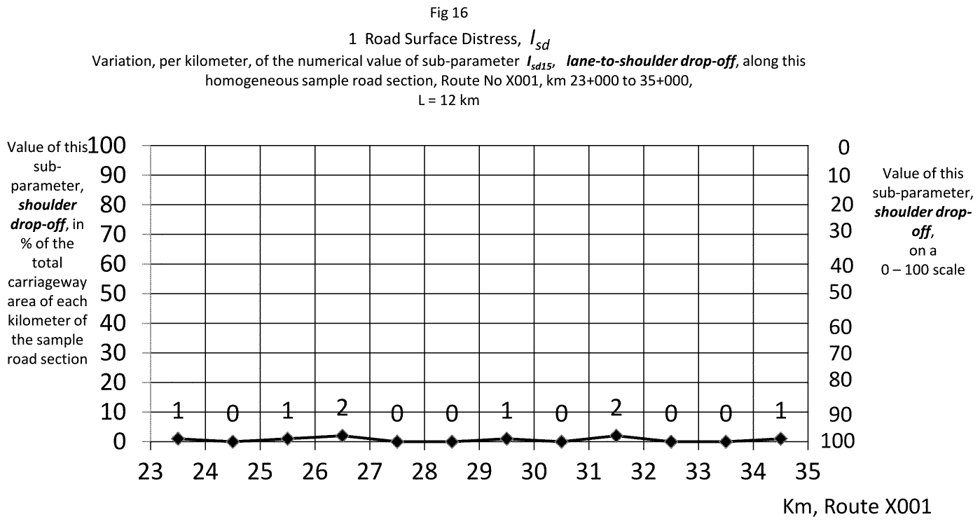

On each kilometer of each homogeneous section of the road network in question the dropped off shoulder areas shall be measured, added together and related to the total shoulders area. In the numerical example a diagram showing the variation of the kilometric value of I_{sd15} along the sample homogeneous road section is given in FIG. 16. (230), (250)

By using the numerical values from the diagram in FIG. 16, the value of I_{sd15}, lane-to-shoulder drop-off, was computed as follows:

$${I}_{s d 15 = \frac{1 + 0 + 1 + 2 + 0 + 1 + 0 + 2 + 0 + 0 + 0 + 1}{12} = \frac{8}{12} = 0.66}$$

A mean value, I_{sd15}=0.66, resulted for this sample road section, which means that, globally, 0.66% of the shoulders area of this pilot section is affected by dropped off shoulders, corresponding to a mean score of 99.34 on the 0-100 scale. See Table 2, column 14. (250)

All values of I_{sdi} calculated as described above, were introduced in the last column of Table 2. A global value of the parameter road surface distress, I_{sdki}, for each kilometer of the sample homogeneous road section, was calculated as an arithmetic sum of the values of the 15 sub-parameters as follows:

$${I}_{sdki} = {\sum }_{i = 1}^{15} {I}_{sdi}$$

where
I_{sdki} the road surface distress index (i.e. the global value of this parameter) for the kilometer i of the sample homogeneous section
I_{sdi} value of this sub-parameter, I_{sdi}, (i=1-15), for the kilometer i, in question, in relationship to all of the 15 sub-parameters. (250)

These values were entered in the Table 2, second last row: the numbers in this row represent the total percentage in which the roadway surface of each kilometer of the sample road section is affected by all the 15 types of distress, i.e. the 15 sub-parameters, put together. The balance to 100%, represents the global numerical value of I_{sd} for each kilometer of the sample homogeneous section, expressed in scores on a 0-100 scale. See Table 2, last row. (250)

Further, the calculation of the road surface distress index, I_{sd}, for the whole 12.0 km sample road section is presented, by using the individual values of each of the 15 sub-parameters as resulted from calculations (and longitudinal diagrams) and performed as described above, in percentages of the whole carriageway area of the pilot section (see Table 2, last column), as follows:

I_{sd}=5.00+5.00+4.50+4.33+4.42+5.17+6.50+5.00+3.92+4.67+4.00+4.08+4.67+5.83+0.66=67.75%

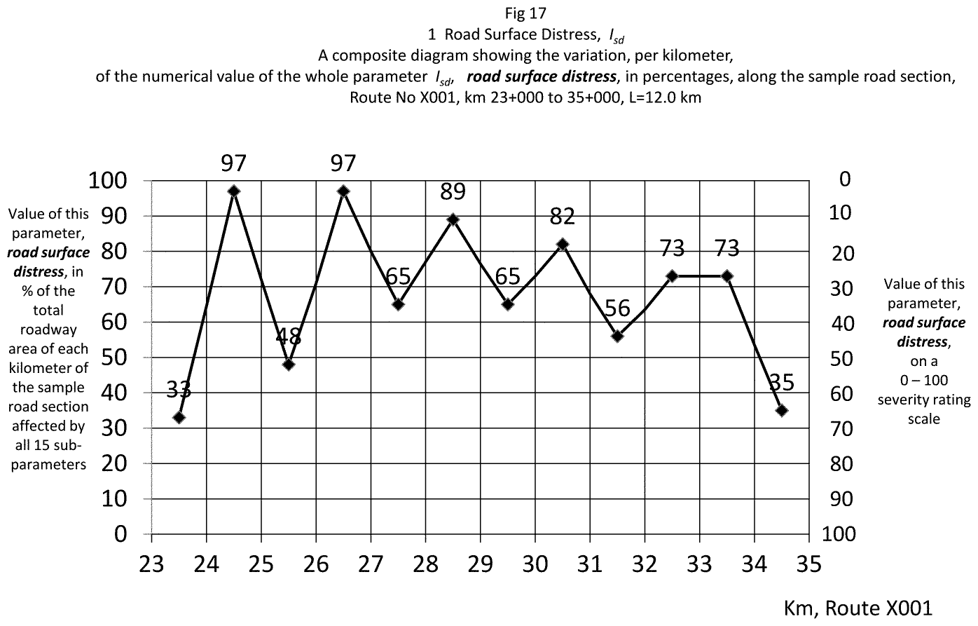

Thus, by summing up the values of the 15 distresses expressed in % of the whole carriageway area of the pilot section, it results that 67.75% of this area is affected by the 15 degradations in various proportions. FIG. 17 shows the variation of these percentages along the whole sample road section. See the vertical (y) axis to the left. To the right of this diagram the 0-100 severity rating scale, in a reverse disposition, as compared to y axis to the left, is shown. (250)

Therefore, the global value of parameter I_{sd}, road surface distress, for the whole sample section, is 100−67.75=32.25 on a 0-100 severity rating scale. The value of I_{sd}=32.25, for the sample road section, which appears at the bottom of last column, is identical with the value of I_{sd} as resulted from the arithmetic mean of the value of I_{sd} for each kilometer separately, i.e. the bottom row of the Table 2. (250)

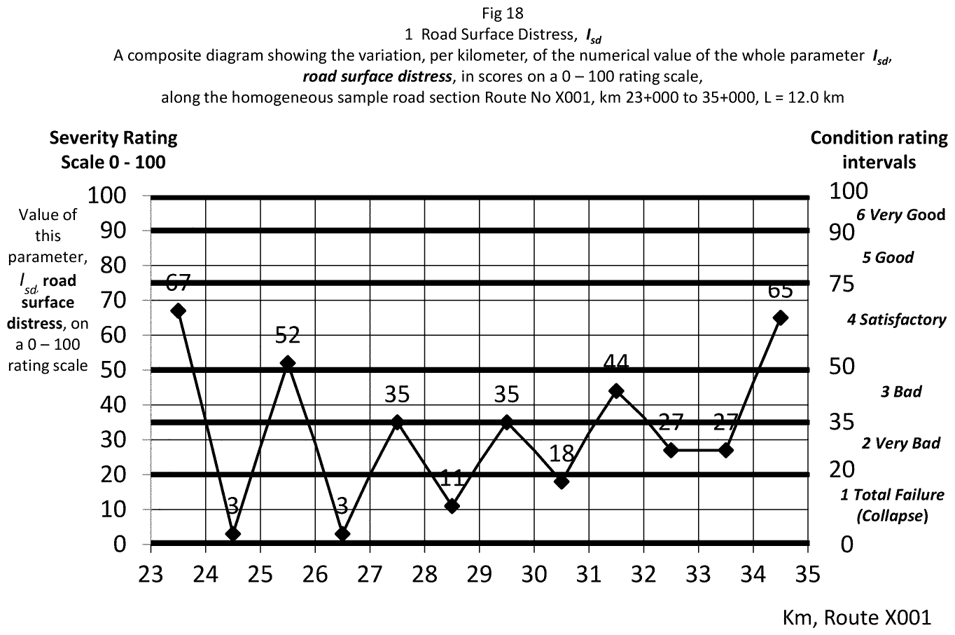

By calculating the differences between 100 and the values expressed in percentages, the values obtained, shown in the bottom row of Table 2, are those converted into values on a 0-100 scale, for a uniform treatment of all parameters. To illustrate the above, a composite diagram, FIG. 18, was constructed in which the variation of the global value of this parameter, kilometer by kilometer, along the sample road section can be seen. In this diagram, on the abscissa, the cumulated values of all sub-parameters, for each kilometer, expressed in percentages but subtracted from 100, were plotted. See Table 2, last row. The 0-100 scale to the left of the diagram, and the 0-100 severity rating scale placed on the right side of the graph, illustrate that.

Table 2 is prepared for the calculation of one condition parameter only, i.e. I_{sd}, for one homogeneous section, in this case the pilot section. For each of the remaining 22 homogeneous sections of the network in question the value of I_{sd} was quantified similarly. Such global numerical values were quantified for each of the remaining 13 condition parameters, and for each of the 23 homogeneous sections of the sample network. (250)

In order to illustrate how the 14 parameters characterize the technical and operational condition of each homogeneous section of the road network in question at a certain date in time, the 14 numerical values shall be aggregated into one global value, by means of a specific formula, and a Global Serviceability Index, I_{gs}, shall be obtained from this aggregation. Table 3 was designed and fulfilled for this purpose. (250)

The global numeric value, 32.25, of the parameter road surface distress, I_{sd}, calculated as described above, is the value entered into the process of aggregation of values of all condition parameters for the respective homogeneous road section. This value is entered into Table 3, row 16, column 7. (250)

Above, the process of assessing the value of the parameter named road surface distress, I_{sd}, was described by using numerical exemplification for one category of road pavements, namely asphalt (or flexible) pavements. For other types of road pavements, such as jointed Portland cement, continuously reinforced concrete surfaces, etc, the procedure of surface distress measurement and condition evaluation shall be preserved, but the series of degradations, hence the sub-parameters, shall differ.

### 2 Drainage System Condition, I_{dsc}

This parameter was placed on 2^{nd} priority given the dramatic influence poor drainage system has upon the whole road body as a civil construction. The water, in its various forms, acts against the road body in its entirety, and against each of its component parts, including the carriageway surface, either actively by its dynamic action, or passively in various forms, literally from all directions: from the air (atmosphere), from the underground (infiltrations, water table etc), from all sides (torrents, flooding, rainwater etc). (210)

In this description, an ideal situation is defined, that in which the system intended for the drainage of water away from the road body, designed and built at the time the latest upgrading of the homogeneous section in question was performed, is perfect, for which situation it is assumed that the parameter named drainage system condition has the value 100. Any deviation from this ideal situation means that at least one component part of the road body is in distress in relation to drainage. (230)

Surveying the drainage system condition of an existing homogeneous road section means the evaluation of at least the following 3 distinct components, herein below called sub-parameters:
Quality of drainage design, or sub-parameter I_{sdc1}
Quality of drainage construction, or sub parameter I_{sdc2}
Quality of drainage maintenance, or sub-parameter I_{sdc3}

### Quality of Drainage Design, I_{dsc1}.

In order to assess the quality of design, each section of the network shall be minutely and exhaustively examined from the drainage needs perspective, and a complete drainage design scope shall be drafted for this purpose, for the realization of a design which should ensure an ideal drainage system, in the sense described above.

The next stage shall be a minute comparative analysis of the previous drainage system designs for the section in question, and highlighting the missing elements, if any, both from the completeness and adequacy standpoints. The difference between the ideal situation, that is a rating score 100, and the actual status shall be assessed; it reflects the quality of drainage design, had, which will be expressed in numerical values on a 0-100 rating scale.

In general, for the parameters 1, 2, 4, 5, 7, 8, 10, 12, 13 and 14, for which surveys, measurements and numerical quantifications are made per kilometer, the value of these 10 condition parameters, cp, and their sub-parameters, csp, shall be calculated as a simple arithmetic mean, by the following relation:

$${I}_{cp / csp} = \frac{{\sum }_{i = 1}^{n} {x}_{i}}{n}$$

I_{cp/csp} value of any of the mentioned condition parameters, or any of their sub-parameters, for the whole homogeneous road section in question
Xᵢ value of any condition parameter/sub-parameter for the kilometer i
n number of kilometers of the homogeneous road section in question

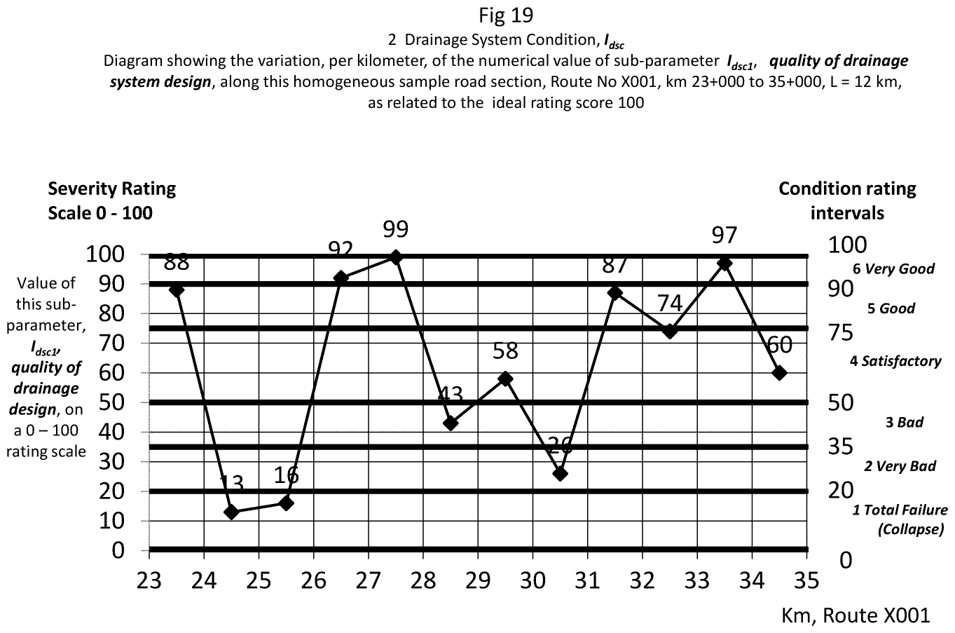

In the numerical example, FIG. 19 illustrates the longitudinal diagram constructed by plotting the quantified values per kilometer of this sub-parameter, along the whole length of the pilot section. (250)

Consequently, by using the numerical values from FIG. 19, and applying the above relation, the value of I_{sdc1} for the whole sample road section was calculated as follows:

$${I}_{d s c 1} = \frac{88 + 13 + 16 + 92 + 99 + 43 + 58 + 26 + 87 + 74 + 97 + 60}{12} = \frac{753}{12} = 62.75$$

which means a mean value for this sub-parameter, I_{dsc1}=62.75, on a 0-100 rating scale. (250)

### Quality of Drainage Construction, I_{dsc2}.

A survey shall be performed for each kilometer of each section of the network in question by checking each constituent part of the drainage system, from the construction adequacy standpoint, and a score on a 0-100 scale shall be quantified and assigned to them.

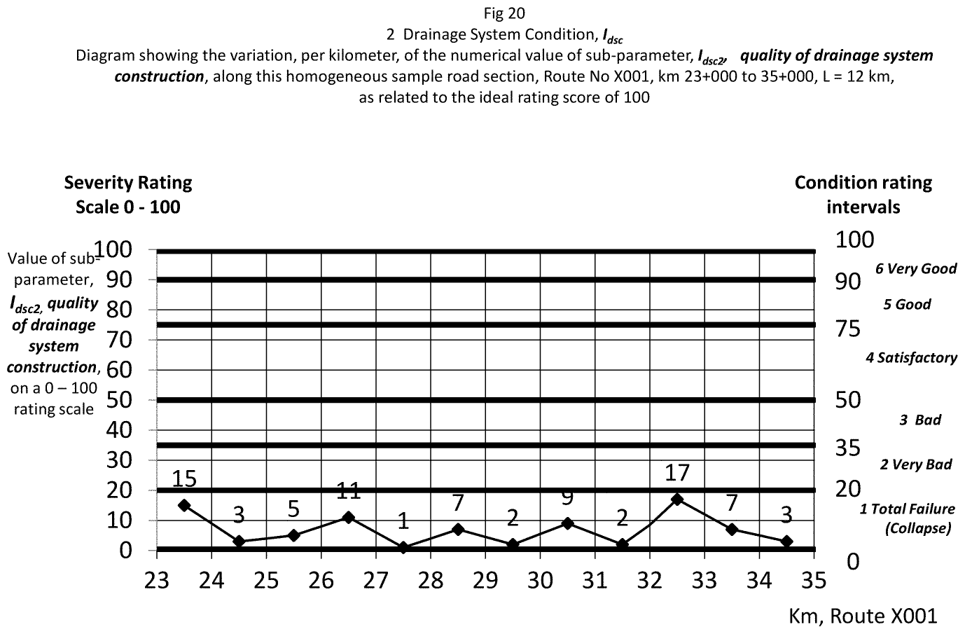

For the numerical example, in FIG. 20 the individual kilometer values of this sub-parameter, I_{dsc2}, were plotted to show its variation, along the sample road section. The numerical value of this sub-parameter, quality of construction, I_{dsc2}, for the whole homogeneous section was calculated, by using the above mentioned formula:

$${I}_{dsc 2} = \frac{15 + 3 + 5 + 11 + 1 + 7 + 2 + 9 + 2 + 17 + 7 + 3}{12} = \frac{82}{12} = 6.83$$

resulting a value for this sub-parameter, I_{dsc2}=6.83, on a 0-100 rating scale.

### Quality of Drainage Maintenance, I_{dsc3}.

The survey of the existing drainage facilities from the quality of maintenance perspective shall cover each kilometer of each section of the network in question, and shall consist in checking each constituent part of the drainage system; a score on a 0-100 scale shall be quantified and assigned to said sections.

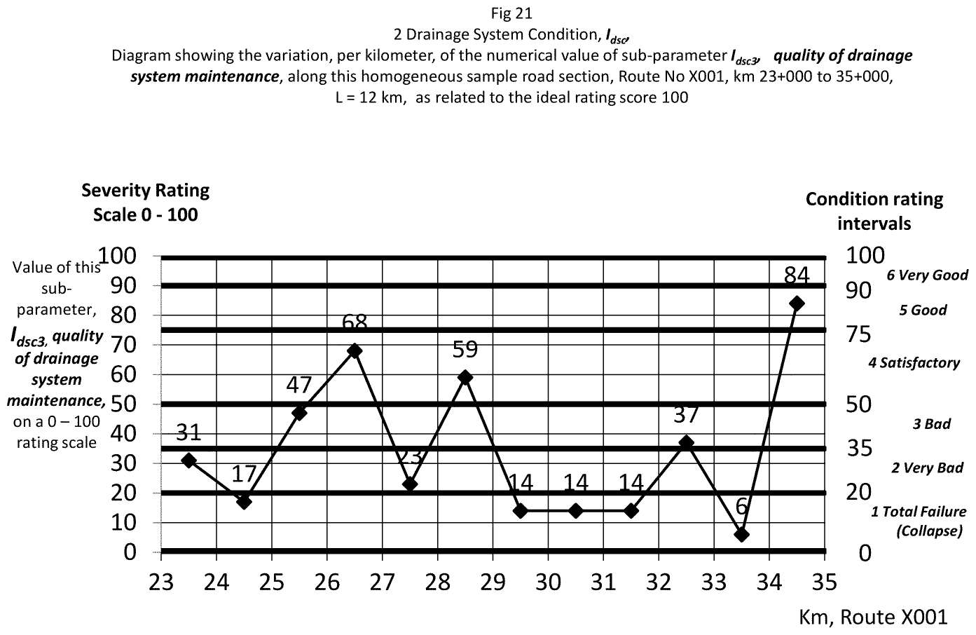

In the numerical example, in FIG. 21 the individual kilometer values were plotted to show the variation of this sub-parameter, I_{dsc3}, along the sample road section. The value of this sub-parameter, quality of maintenance, I_{dsc3}, for the whole homogeneous section was calculated, by using the formula mentioned above:

$${I}_{dsc 3} = \frac{31 + 17 + 47 + 68 + 23 + 59 + 14 + 14 + 14 + 37 + 6 + 84}{12} = \frac{414}{12} = 34.50$$

and a value for it, I_{dsc2}=34.50, on a 0-100 scale, was obtained.

The values I_{dsci}, i=1-3, calculated as described above, were introduced in the last column of Table 4. A global value of this parameter, drainage system condition, I_{dsc}, for each km of the sample homogeneous road section, was calculated as the arithmetic mean of the values of the 3 sub-parameters for the respective kilometer, as follows:

$${I}_{dsckj =} \frac{{\sum }_{i = 1}^{3} Idsci}{3}$$

I_{dsckj} the drainage system condition index (i.e. the global value of this parameter) for the kilometer j of the sample homogeneous section
   I_{dsci} value of sub-parameter i (i=1-3), for the kilometer j, in relationship to all 3 sub-parameters.
   Those values were entered in Table 4, last row.

The global numerical value of this parameter, I_{dsc}=34.69, in the bottom cell of the last column, was further entered into Table 3, row 16, column 9. (250)

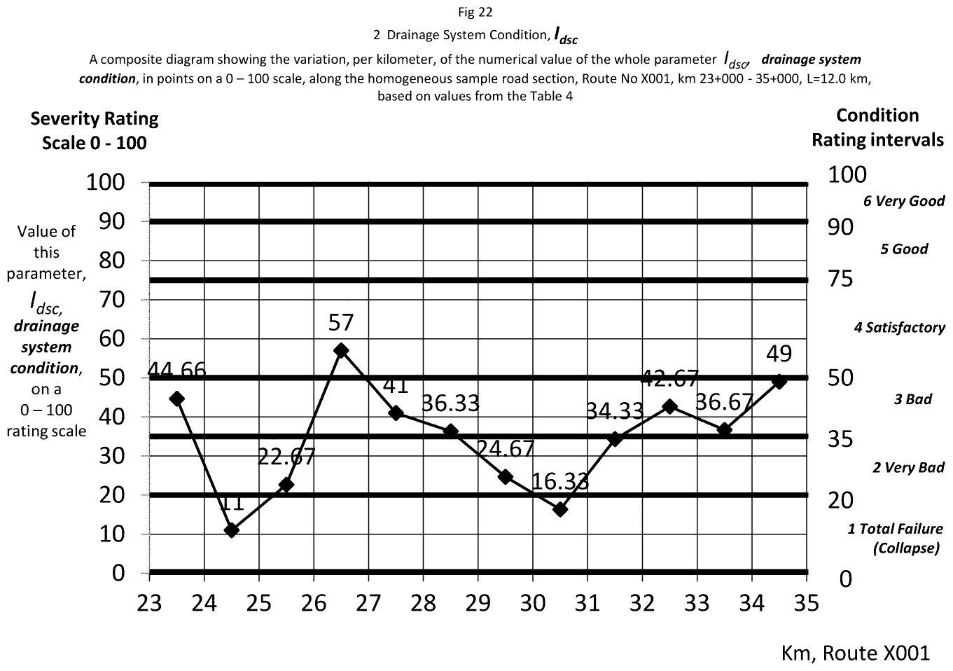

In the numerical example, in FIG. 22, the individual mean kilometer values of I_{dsc}, for each kilometer of the sample road section, in points on a 0-100 scale, were plotted.

Instead of dividing (and surveying) the homogeneous sections by kilometer, as individual homogeneous sub-sections, they can also be divided into homogeneous sub-sections of various other lengths, based on uniform or quasi uniform drainage condition characteristic to distinct sub-sections. The actual length of homogeneous sub-sections in this case shall be dictated by the drainage system condition characteristic to such individual sub-sections rather than to individual kilometers. In this case the drainage system condition, I_{dsc}, for the whole road section in question shall be calculated as a weighted arithmetic mean of the drainage system condition values characteristic to each homogeneous sub-section by the same formula indicated under bearing capacity parameter.

Uniform drainage condition shall be ensured along a section carrying a constant, uniform amount of traffic.

### 3 Bearing Capacity of the Road Body, I_{bc}

In the context of this invention the bearing capacity refers to the road body as a whole, that is the pavement structure, the embankment, if any, and the natural ground, or sub-grade, on which the road is founded and built. Any degradations which occur in any of the above 3 major constituents of the road body, and any improper maintenance and operations on one of them will diminish the overall bearing capacity (210). This parameter is placed on No 3 priority after surface distress and drainage system condition. Surveying on this parameter shall cover the following:
Quality of structural design performed when the latest major upgrading was done on the section in question
Quality of construction of the latest major upgrading performed
Quality of maintenance and repairs after the latest major upgrading
Quality of operations after the latest upgrading;
   All the above elements shall be considered as sub-parameters of I_{bc}, or bearing capacity of road body

### Quality of Design, I_{bcd}.

The following 2 items shall be checked in this respect is (1) whether the latest structural design was properly done, and (2) whether the bearing capacity diminished more (or less) rapidly than scheduled.

### Quality of Construction, I_{bcc},

The bearing capacity can also diminish earlier than designed during the predicted life span of the latest upgrading, due to poor quality of construction of those parts of the road which ensure the strength; they shall be checked a posteriori.

### Quality of Maintenance and Repairs, I_{bcm}.

Notwithstanding the structural design and execution, which could have been good, if maintenance and repairs have been poor, bearing capacity could lessen at an accelerated rate.

### Quality of Operations, I_{bco}.

The following elements shall be considered when surveying the quality of operations: irrational use of a road could mean, without being limited to, (1) carrying a number of ESALs per unit of time larger than that prescribed at the design stage in the operating instructions, (2) passing of axles loaded with more than legally allowable weights, (3) failure to observe the guidelines on pavement structure operations, particularly in winter, spring and fall when the humidity is higher and freeze-thaw cycles are more frequent and severe than the rest of the year. The diminution of bearing capacity at normal rate shall also be surveyed. (230)

### Bearing Capacity Index, I_{bc}.

Structural assessment of road body implies the measurement of deflections under known loadings on each traffic lane, longitudinally. The deflection, actually the pavement elastic rebound, shall be measured in hundredths of millimeters. To the extent possible measurements shall be made by an instrument that regularly measures the deflection at equal length intervals, as short as possible, so that a longitudinal deflectogram is obtained for each traffic lane of each homogeneous section; this has the advantage of not missing out small areas where local failures could exist and be overlooked. (230)

In order to characterize a homogeneous road section from the bearing capacity perspective the longitudinal deflectogram, or any other type of similar deflection measurements, shall be used as a basis for further dividing the section into homogeneous sub-sections, hence as a function of the value of deflections characteristic to a distinct sub-section. This time the division of the homogeneous section will not be into portions of 1.0 km long; the actual length of the homogeneous sub-sections will be dictated by the deflectogram itself or other similar type of deflection measurements, and its corresponding graphical representation, which will show uniform or quasi uniform bearing capacity. To a road section which carries a constant, uniform amount of traffic, uniform bearing capacity should be ensured on its whole length, corresponding to the traffic volume it carries, even if this shall be achieved by a differentiated treatment of sub-sections that are in turn, homogeneous in respect to bearing capacity. (250)

The bearing capacity index, I_{bc}, for the whole road section in question shall be calculated as a weighted arithmetic mean of the characteristic deflections for each homogeneous sub-section by the formula:

$${I}_{bc} = \frac{{\sum }_{i = 1}^{n} {x}_{i} {l}_{i}}{{\sum }_{i = 1}^{n} {l}_{i}}$$

I_{bc} Bearing Capacity Index for the whole homogeneous section
xᵢ value of characteristic deflection for sub-section i, homogeneous in relationship to bearing capacity, resulted from the deflection diagram
lᵢ length, in kilometers, of the homogeneous sub-section i, along which the deflectogram is constant or quasi constant
n number of homogeneous sub-sections, in relationship to bearing capacity, resulted from the deflection diagram

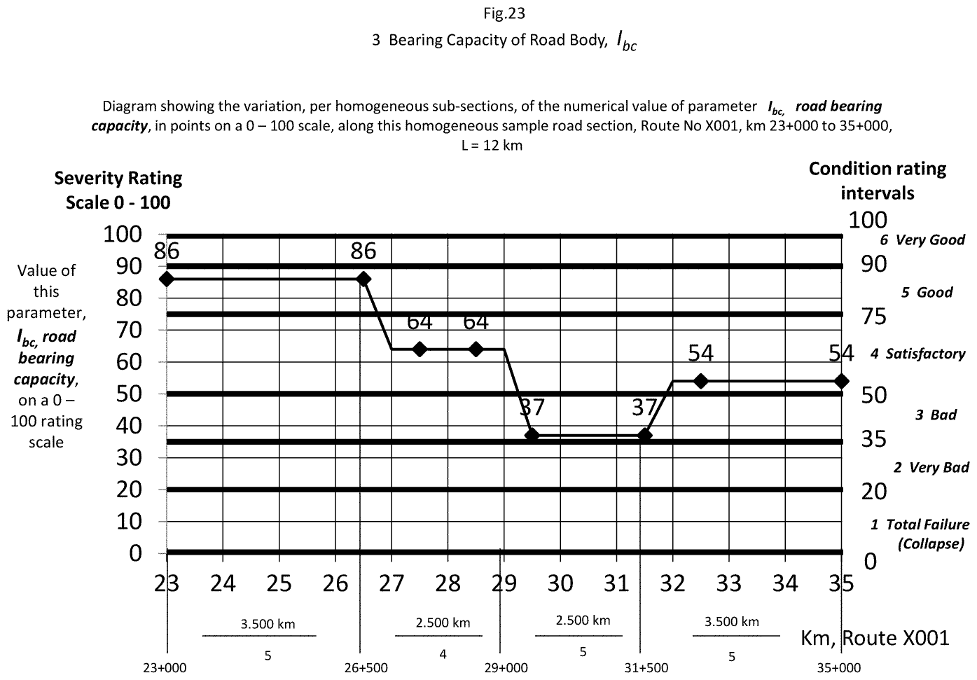

In the numerical example, by applying the above mentioned formula and using the numeric values of FIG. 23, the global value of I_{bc} was calculated as follows:

$${I}_{bc} = \frac{86 \times 3.5 + 64.0 \times 2.5 + 37.0 \times 25 + 54.0 \times 35}{3.5 + 25 + 25 + 35} = \frac{742.5}{12} = 61.88$$

The global numerical value, I_{bc}=61.88, was entered into the Table 3, row 16, column 11. (250)

It should be noted that the sample homogeneous road section is divided into 4 sub-sections, all homogeneous in relationship to bearing capacity, having the following lengths: 3.500 km, 2.500 km, 2.500 km and 3.500 km. See deflection diagram in FIG. 23.

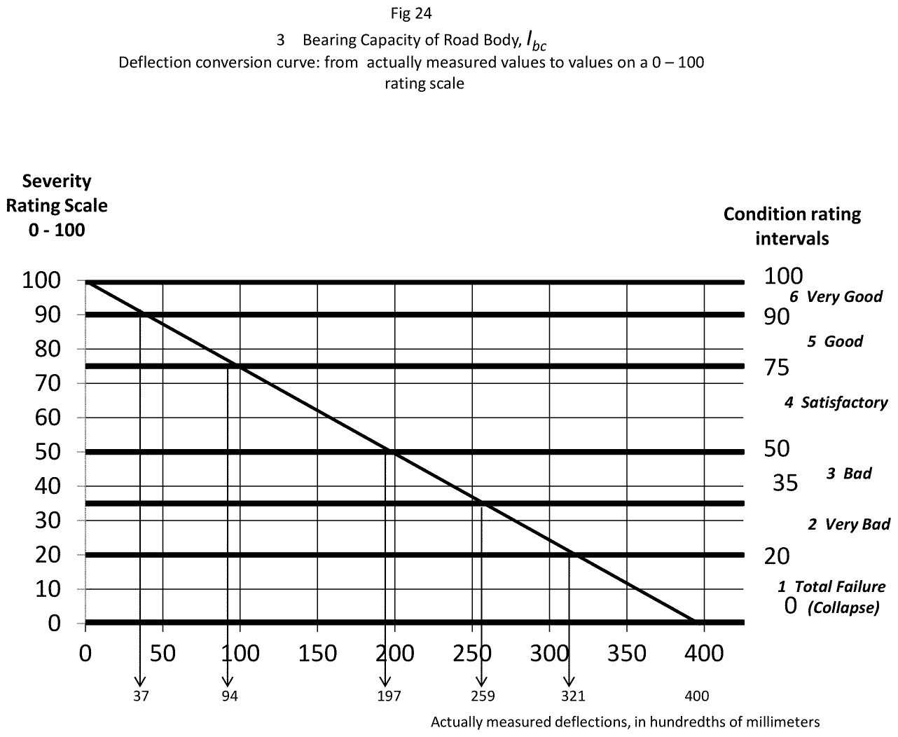

For the same reason of uniformly treating all the condition parameters, a similar 0-100 rating scale shall be used, and deflection values shall be determined by means of a conversion curve. See FIG. 24. The principle of the conversion curve is the following: on the horizontal (x) axis (abscissa) the values of deflections actually measured in the field, in hundredths ( 1/100) mm, shall be plotted, and on the vertical axis (y), the corresponding value of the Bearing Capacity Index shall be determined in values on the 0-100 rating scale. (250)

The value of 400 hundredths millimeters was selected as a maximum allowable value for the deflection since this is the number generally accepted for a total failure of the road body with reference to bearing capacity, hence value zero on the 0-100 scale.

The converted values corresponding to the 6 condition rating intervals, as extracted from diagram in FIG. 24, are: for interval 1(0-20), or Collapse, 321 mm-400 mm; for interval 2(20-35), or Very Bad, 259 mm-321 mm; for interval 3(35-50), or Bad, 197 mm-259 mm; for interval 4(50-75), or Satisfactory, 94 mm-197 mm; for interval 5(75-90), or Good, 37 mm-94 mm, and for interval 6(90-100), or Very Good, 0(zero) mm-57 mm. (250)

### 4 Traffic Safety Level Iₜₛ

In case all previous 3 parameters are at acceptable condition severity levels, traffic safety is the next concern both for motorists and government authorities. This parameter covers all the road features, components and specific equipment relating to road traffic safety. In any traffic accident 4 main factors are involved: the infrastructure, the vehicle, the driver, and the legislation that regulates the road transportation traffic and its safety. The cause of any road accident is always divided between these four factors but never in equal parts. Regardless the nature of an accident, the infrastructure has its own weight, smaller or bigger, which should be identified, surveyed, quantified and remedied. The ideal situation, for which a score of 100 is given, is when there are no traffic accidents along the section in question due to infrastructure condition. (210)

Each homogeneous section of the network shall be surveyed, kilometer by kilometer, from the traffic safety perspective, on the basis of very detailed and comprehensive guidelines in which at least the following main elements shall be pursued: traffic control devices, traffic accidents, road equipment specific to traffic safety, equipment pertaining to intelligent transportation systems, the physical infrastructure (alignment geometry, surface distress, riding surface roughness, skid resistance, embankment and natural ground stability, winter serviceability, level of service), to name only a few of this extremely complex parameter. To each kilometer surveyed a 0-100 scale severity score shall be assigned. (230)

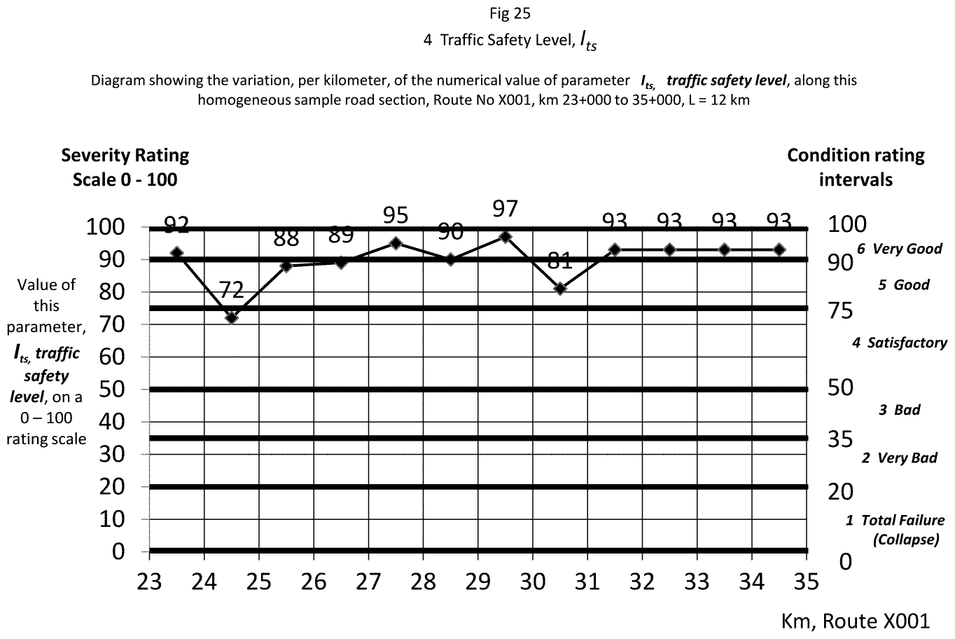

In the numerical example, for the sample road section, the diagram in FIG. 25 was drawn, which shows the variation, along this section, of values per kilometer of parameter Iₜₛ, traffic safety level, along the sample road section. By using these numbers the value of Iₜₛ was calculated as follows:

$${I}_{ts} = \frac{92 + 72 + 88 + 89 + 95 + 90 + 97 + 81 + 93 + 93 + 93 + 93}{12} = \frac{1076}{12} = 89.67$$

The global numerical value, Iₜₛ=89.67, was entered into the Table 3, row 16, column 13. (250)

Instead of dividing (and surveying) the homogeneous sections by kilometer, they can also be divided into homogeneous sub-sections of various other lengths based on uniform or quasi uniform traffic safety conditions characteristic to distinct sub-sections. The actual length of the homogeneous sub-sections shall be dictated by the traffic safety conditions characteristic to such individual sub-sections. In this case the traffic safety index, Iₜₛ, for the whole road section in question shall be calculated as a weighted arithmetic mean of the traffic safety values characteristic to each homogeneous sub-section.

Uniform traffic safety shall be ensured along a road section carrying a constant, uniform amount of traffic.

### 5 Road Surface Roughness, Iᵣᵣ,

Iᵣᵣ refers to the road riding surfaces. This parameter was ranked on 5^{th} place: regardless of nature, type and category of unevenness the perception is longitudinal for longitudinal undulations and transverse for ruts. (210)

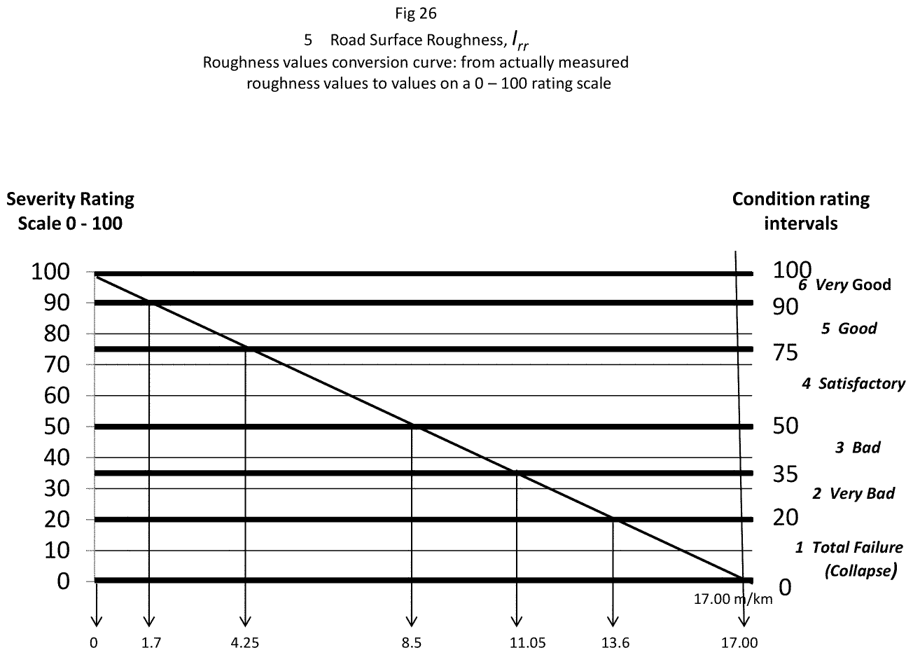

In this parameter, the longitudinal and transverse profile of all homogeneous road sections shall be surveyed, at the same time as all the other parameters, and the results obtained plotted on a longitudinal diagram, called profilogram. The ideal situation shall be when the measured and recorded profile is identical or very close to that recorded at the completion of the latest major upgrading done on the link in question which should have been preserved for such purposes, supposedly that profilogram fell in the upper part of the severity rating scale. The measurement results recorded should be expressed and presented in a uniform reference system which is a 0-100 rating scale. The most common and generally recognized reporting system for the road roughness is the IRI, or International Roughness Index, expressed in meters per kilometer of cumulated measured roughness. The roughness measurement shall be made preferably by means of an instrument which gives the results directly in IRI values. If such an instrument is not available the measurement results shall be first converted into IRI values and then into 0-100 values. By means of a conversion curve, given in FIG. 26, the values of Iᵣᵣ on a 0-100 rating scale are obtained. (230)

The value of IRI=17.0 m/km was chosen because this is generally recognized and accepted as a maximum value corresponding to “total failure” of a road surface in relation to roughness. The value IRI=0 corresponds to 100 on the 0-100 scale. FIG. 26. (230)

The converted values corresponding to the 6 condition rating intervals, as extracted from the diagram in FIG. 26, are: for interval 1(0-20), or Collapse, 13.60 m-17.00 m; for interval 2(20-35), or Very Bad, 11.05 m-13.60 m; for interval 3(35-50), or Bad, 8.50 m-11.05 m; for interval 4(50-75), or Satisfactory, 4.25 m-8.50 m; for interval 5(75-90), or Good, 1.70 m-4.25 m; and for interval 6(90-100), or Very Good, 0.00 m-1.70 m. (230)

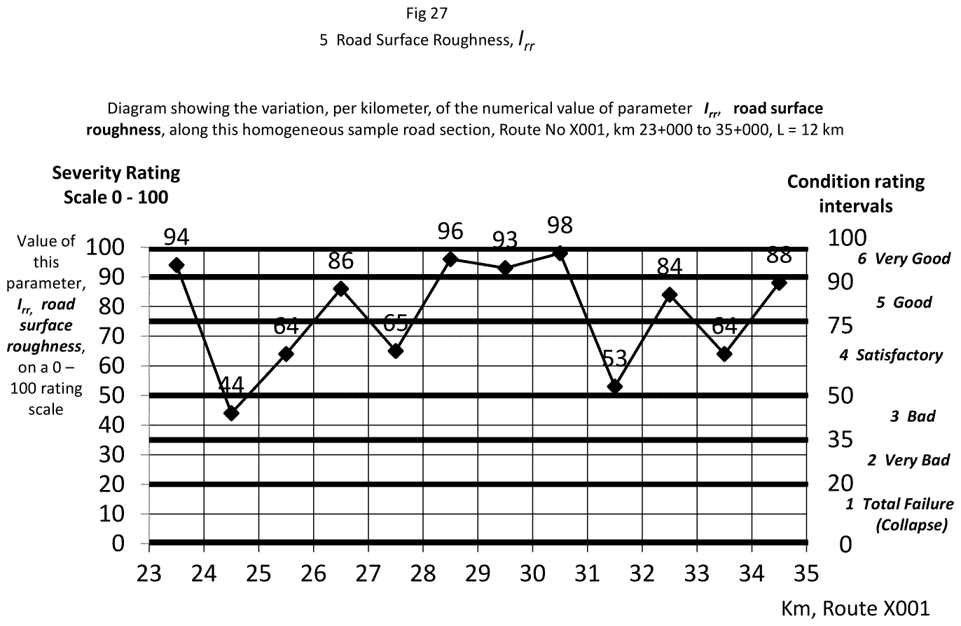

In the numerical example, diagram in FIG. 27 shows the variation of numerical values per kilometer of parameter Iᵣᵣ, road surface roughness, along the sample road section. By using these numbers the value of Iᵣᵣ, for the whole homogeneous sample section, was calculated as follows:

$${I}_{rr} = \frac{94 + 44 + 64 + 86 + 65 + 96 + 93 + 98 + 53 + 84 + 64 + 88}{12} = \frac{929}{12} = 77.42$$

The global numerical value of this parameter, Iᵣᵣ=77.42, was entered into the Table 3, row 16, column 15. (250)

### 6 Skid Resistance Index, Iₛᵣ,

Iₛᵣ refers to another feature of road riding surfaces. Being ranked No 6 on the order of importance, this parameter refers to road carriageway surface. The deficiency in this context is the loss of skid resistance due to road travelled surface having become polished or other reasons. (210)

In this context the generally known Euler friction coefficient is used, defined as the ratio, μ, between the two forces which oppose the movement in two opposite directions of two objects being in contact to each other on a certain known area: the horizontal force that opposes the movement, Fᵣ, and the force normal on the contact area, Fₙ:

$$μ = \frac{{F}_{r}}{{F}_{n}}$$

The parameter called skid resistance, Iₛᵣ, is actually the Skid Number defined as SN=100μ From the long time practice of skid resistance measurements on the whole range of road pavements, and following the whole variety of characteristics of the measuring instruments, it became generally accepted that the value of skid resistance coefficient is situated within 0.05-1.05 interval. Hence, the Skid Number shall be situated between 5 and 105. (210)

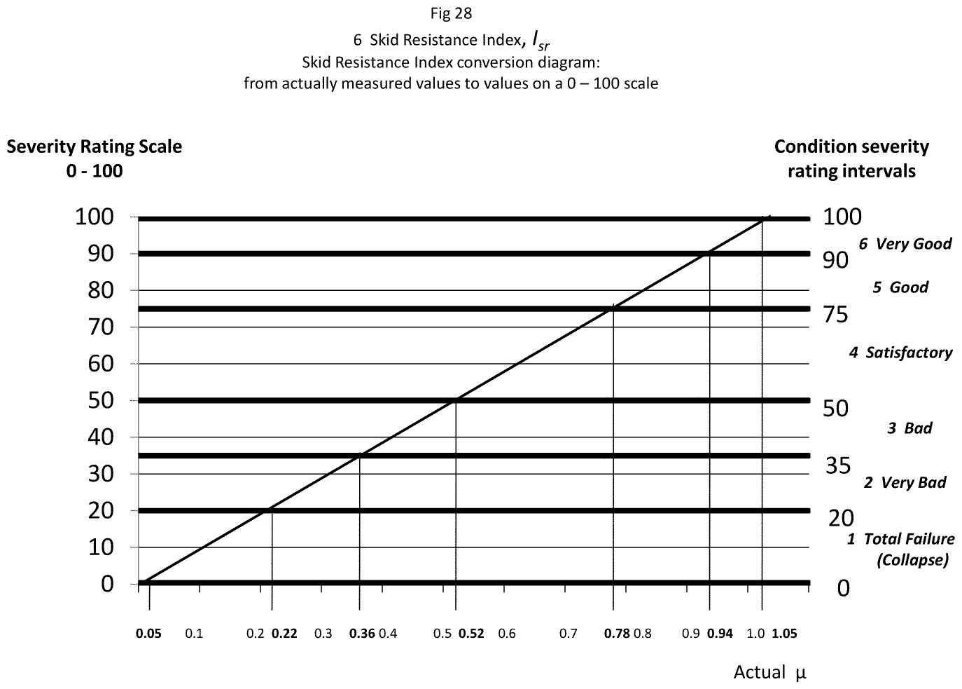

In order to work with values on a 0-100 rating scale, the values of SN shall be brought into this interval by means of the conversion diagram shown in FIG. 28. (250)

The converted values corresponding to the 6 condition rating intervals, as extracted from diagram in FIG. 28, are: for interval 1(0-20), or Collapse, 0.05(SN=5.0)-0.22(SN=22); for interval 2(20-35), or Very Bad, 0.22(SN=22)-0.36(SN=36); for interval 3(35-50), or Bad, 0.36(SN=36)-0.52(SN=52); for interval 4(50-75), or Satisfactory, 0.52(SN=52)-0.78(SN=78); for interval 5(75-90), or Good, 0.78(SN=78)-0.94(SN=94), and for interval 6(90-100), or Very Good, 0.94(SN=94)-1.05(SN=105). (250)

It is essential that, to the extent possible, the equipment employed in measuring the skid resistance furnishes the results directly in SN=100μ values. Also, such instruments shall be employed which have standardized characteristics of active measuring parts, like test tire, contact area, contact shape, normal load, and which offer a continuous measuring regime in the variant of longitudinal sliding with braked wheel at a braking rate as small as possible so the wear of the test tire be as small as possible. Also, instruments which furnish a continuous longitudinal variation of the skidding coefficient, with as many readings per unit of length as possible, e.g. per meter, shall be employed, yielding a skid diagram so that the road section in question can be easily divided into sub-links which are homogeneous from the skid resistance perspective. The measuring speed should be as high as possible for productivity reasons. (230)

Under such circumstances the Skid Number for a whole homogeneous section shall be calculated as a weighted arithmetic mean of the characteristic skid resistance for each road sub-link, which is homogeneous from this perspective, by the formula:

$$S N = \frac{{\sum }_{i = 1}^{n} {x}_{i} {l}_{i}}{{\sum }_{i = 1}^{n} {l}_{i}}$$

SN Skid Number for the whole homogeneous section
xᵢ value of characteristic skid number for sub-section i, homogeneous from the skid resistance perspective, resulted from the corresponding skid diagram
lᵢ length, in kilometers, of the homogeneous sub-section i, established by the skid diagram
n number of homogeneous sub-sections, from the skid resistance perspective, resulted from the skid diagram

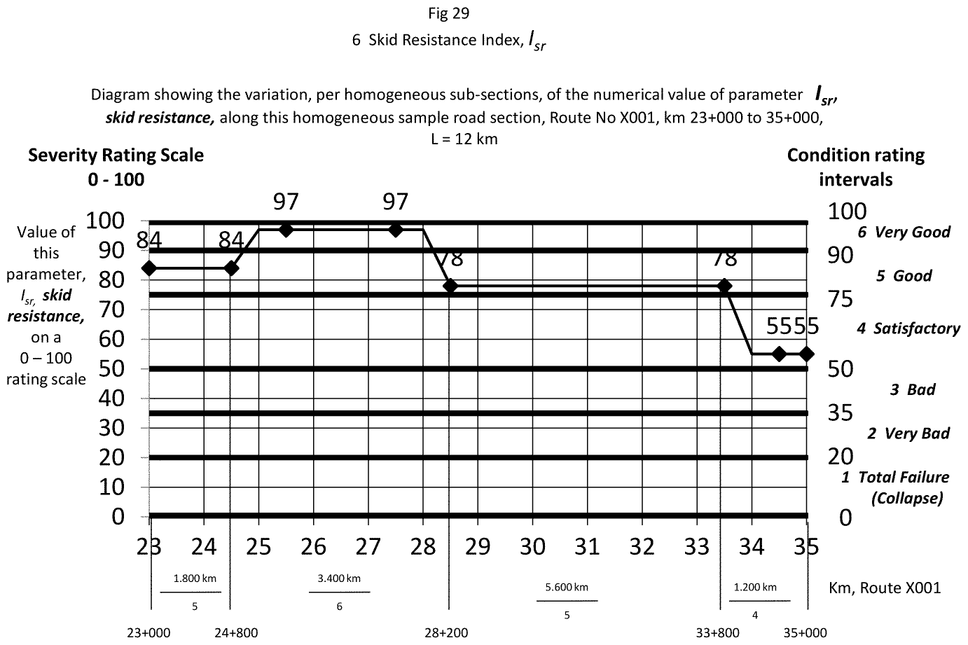

In the numerical example, diagram in FIG. 29 shows the variation of numerical values per homogeneous sub-links of parameter Iₛᵣ skid resistance, along the sample road section. By using these numbers and the formula described above, the value of Iₛᵣ was calculated as follows:

$${l}_{sr} = \frac{84 \times 1.80 + 97 \times 3.40 + 78 \times 5.60 + 55 \times 1.20}{1.80 + 340 + 5.60 + 120} = \frac{1 \text{,} 043.80}{12} = 86.98$$

The global numerical value of this parameter, Iₛᵣ=86.98, was entered in the Table 3, row 16, column 17.

It should be noted that the sample homogeneous road section is divided into 4 sub-sections, all homogeneous in relationship to skid resistance, having the following lengths: 1.800 km, 3.400 km, 5.600 km and 1.200 km. See diagram in FIG. 29.

Uniform skid resistance should be ensured along a section carrying a constant, uniform amount of traffic. (250)

### 7 Geometric Adequacy Index, I_{ga},

I_{ga} refers to the whole road alignment as a civil construction. Any road link of the network in question could be in very good condition in relationship to all previous condition parameters, which could have a value between 90 and 100, but still not be satisfactory for the users due to its poor geometry: small radius curves, steep gradients, lack of super elevations and super widening, etc. This leads to longer travel times, higher fuel consumption, higher vehicle operating costs, higher pollution (air, water, soil, and noise), stress and tiredness of drivers, lack of traffic safety. (210)

To substantiate the reduction to practice of this invention the concept of optimal geometry is introduced, which means performing a technical-economic cost-benefit study to establish the best alignment geometry for the best economic alternative. (210)

The optimal geometry implies the realization of a geometrically harmonious alignment, more reasonably convenient for the users. The better the initial geometry (hence, closer to the optimal geometry), i.e. the higher the initial investment, the smaller the subsequent maintenance and operations expenses. Similarly, the vehicle operating costs are smaller, thus the long term benefits recorded are higher; it is worth mentioning the reduction in constructions costs due to a shorter alignment. (210)

The optimal geometry shall be established for each link of the network in question, and then the actual alignment geometry on the ground shall be surveyed and evaluated by comparison with optimal geometry. A numerical score shall be assigned to it, which, for uniformity purposes, shall fall within a 0-100 points interval. (210)

The quality of design of the latest major upgrading of the alignment in question is the basic element to start from. To this end a field survey of each section shall be done, an assessment of what should be the optimal geometry shall be performed, and a comparison between the two shall be made to assess the existing geometric adequacy of the alignment. In order that an evaluation as accurate as possible be achieved, 9 sub-parameters were selected for this parameter: I_{ga1}, part of the section in curve, I_{ga2}, road portions without transition curves, I_{ga3}, curves without super-elevation, I_{ga4}, carriageway width, I_{ga5}, shoulder width, I_{ga6}, intersections, I_{ga7}, the gradients, I_{ga8}, slow moving traffic lanes, I_{ga9}, visibility. (230)

For the numerical exemplification the downward and upward gradients, or I_{ga7}, were taken. To assess the value of this sub-parameter the following scale of values shall be applied for the existing geometry:

| | |
|---|---|
| For gradients of 9% and higher, value of sub parameter is | 8 points |
| For gradients of 8% to 9%, value of sub parameter is | 15 points |
| For gradients of 7% to 8% , value of sub parameter is | 25 points |
| For gradients of 6% to 7%, value of sub parameter is | 40 points |
| For gradients of 5% to 6%, value of sub parameter is | 55 points |
| For gradients of 4% to 5%, value of sub parameter is | 75 points |
| For gradients of 3% to 4%, value of sub parameter is | 85 points |
| For gradients of 0-3%, value of sub parameter is | 100 points |

The homogeneous section in question shall be divided into sub-sections, all homogeneous from the longitudinal gradient perspective, by values between 0-9% as above. The value of this sub-parameter shall be obtained by computing the weighted average of the scores as follows:

$${I}_{ga 7} = \frac{{\sum }_{i = 1}^{n} {p}_{i} {l}_{i}}{{\sum }_{i = 1}^{n} {l}_{i}}$$

I_{ga7} current gradient index of the whole homogeneous section
pᵢ gradient index on the scale described above, for sub-section i
lᵢ length of sub-section having gradient pᵢ
n number of sub-sections

The same reasoning shall be applied to the quantification of all the other 8 sub-parameters and a longitudinal variation diagram shall be produced for each of the 9 sub-parameters. A value per kilometer, and/or per homogeneous sub-section, shall be calculated using the numerical data from the pertinent diagrams. (250)

The value of the geometric adequacy index, I_{ga}, for each kilometer, shall be computed as an arithmetic mean of the value of all 9 sub-parameters, as follows:

$${I}_{g a} = \frac{{I}_{g a 1} + {I}_{g a 2} + … … + {I}_{g a 9}}{9}$$

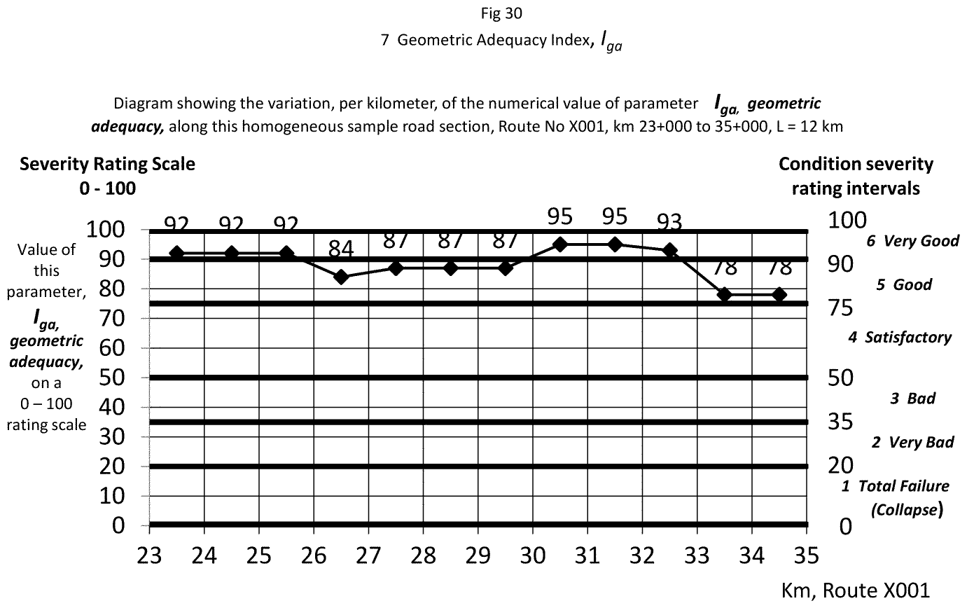

In the numerical example, the diagram in FIG. 30 shows the variation of the 9 aggregated numerical values of parameter I_{ga}, geometric adequacy index, per kilometer, along the sample road section. By using these numbers the value of I_{ga} was calculated as follows:

$${I}_{g a} = \frac{92 + 92 + 92 + 84 + 87 + 87 + 87 + 95 + 95 + 93 + 78 + 78}{12} = \frac{968}{12} = 80.67$$

The global numerical value of this parameter, I_{ga}=80.67, was entered into the Table 3, row 16, column 19. (250)

Instead of dividing (and surveying) the homogeneous section by kilometer, it can also be divided into homogeneous sub-sections of various other lengths based on uniform or quasi uniform geometric adequacy characteristic to such distinct sub-sections. The actual length of the homogeneous sub-sections shall be dictated by the geometric adequacy characteristic to each individual sub-section, and to each sub-parameter. In this case the geometric adequacy index, I_{ga}, for the whole road section in question shall be calculated as a weighted arithmetic mean of the geometric adequacy values characteristic to each homogeneous sub-section.

Uniform geometric adequacy should be ensured along a section carrying a constant, uniform amount of traffic.

### 8 Natural Ground Stability Index, I_{ngs},

I_{ngs} is next in the order of importance. It refers to the natural ground (sub-grade) a road is built upon. In susceptible areas all the sections of the network in question shall be permanently placed under surveillance and measurements by specific means in order to detect possible movements of the ground and, once a year, when collecting the data, a global evaluation of each homogeneous section of the network shall be performed, kilometer by kilometer, the portions having possible problems being highlighted accordingly. Those portions of the homogeneous sections which do not bear any problems shall be given the score 100, and the sections affected shall be given a score corresponding to the severity of instability. (250)

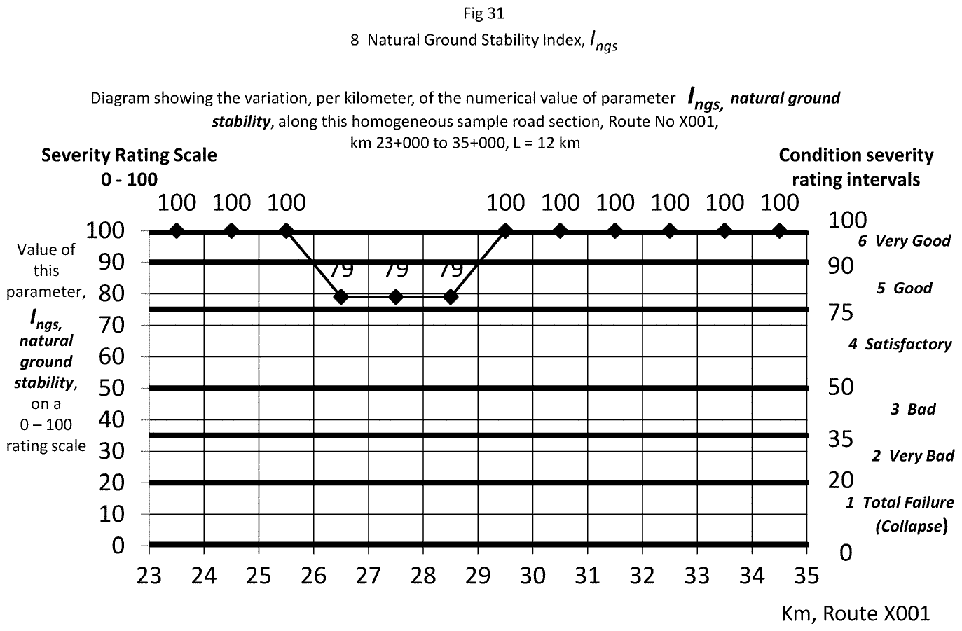

In the numerical example, the diagram in FIG. 31 shows the kilometric variation of numerical values, of parameter I_{ngs}, natural ground stability index, along the sample road section. By using these numbers, the value of I_{ngs} for the whole homogeneous section in question was calculated as an arithmetic mean:

$${I}_{ngs} = \frac{\begin{matrix}100 + 100 + 100 + 79 + 79 + 79 + 1 \; 00 + \\ 100 + 100 + 100 + 100 + 100\end{matrix}}{12} = \frac{1137}{12} = 94.75$$

The global numerical value of this parameter, I_{ngs}=94.75, was entered into the table 3, row 16, column 21. (250)

Instead of dividing (and surveying) the homogeneous sections by kilometer, they can also be divided into homogeneous sub-sections of various other lengths, based on uniform or quasi uniform natural ground stability characteristic to distinct sub-sections. Hence, the actual length of the homogeneous sub-sections shall be dictated by the natural ground stability characteristic to such individual sub-sections, and the value of I_{ngs} for the whole section in question shall be calculated as a weighted arithmetic mean of the natural ground stability values characteristic to each homogeneous sub-section. When remedial works are to be prescribed for raising the value of this parameter to severity level 6(90-100), the alternative of relocating some portions of the road section in question, to completely avoid ground stability issues, shall be considered.

Uniform natural ground stability shall be ensured along any section carrying a uniform amount of traffic.

### 9 Road Body Stability Index, I_{rbs},

I_{rbs} refers exclusively to what is above the natural ground, i.e. road embankment, if any, and pavement structure. I_{rbs} is introduced as a condition parameter since the road embankment, which exists in roughly 50% of any road alignments, is an important component part of the road body and its stability is paramount to maintaining bearing capacity and other condition parameters at their respective levels. (210)

Road embankment instability can be caused by a large number of factors such as poor design and construction, lack of proper maintenance, poor drainage system, lack of appropriate protection, extraordinary rainfalls, earthquakes, flash floods and others. (210)

All sections in fill and/or in composite cross-section of the road network in question shall be kept under continuous surveillance and displacement measurements made for detecting any possible movements of the road body in relationship to natural ground. Every year, an exhaustive evaluation of each homogeneous section of the network, from the road body stability perspective, shall be carried out, and the portions showing signs of embankment instability shall be evidenced accordingly. Depending on the severity of the problem an appropriate score, on a 0-100 rating scale, shall be quantified and assigned to each such sub-section. (230)

All homogeneous sections of the network in question shall be divided into sub sections which, in turn, are homogeneous from the road body stability perspective. Numerical scores shall be quantified and assigned to each sub-section showing instability (250). The value of the road body stability index for the whole section shall be obtained by computing the weighted average of scores as follows:

$${I}_{rbs} = \frac{{\sum }_{i = 1}^{n} {s}_{i} {l}_{i}}{{\sum }_{i = 1}^{n} {l}_{i}}$$

I_{rbs} road body stability index of the whole homogeneous section in question
sᵢ stability index on a 0-100 rating scale, for sub-section i
lᵢ length of sub section i having stability index sᵢ
n number of sub sections homogeneous in relationship to road body stability index

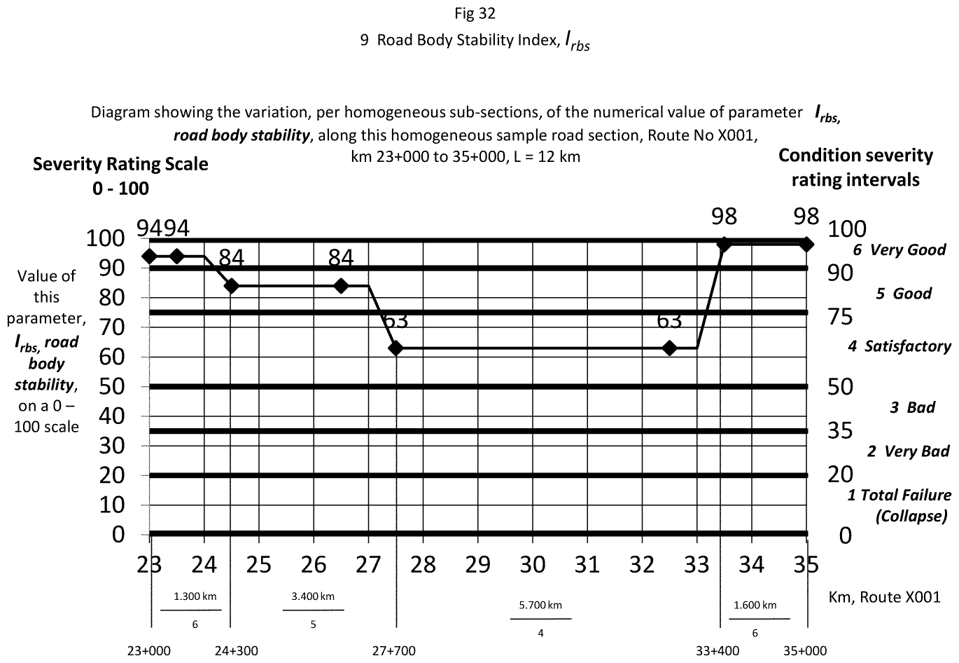

In the numerical example, by using the data from diagram in FIG. 32, the value of I_{rbs} for the whole sample homogeneous section was computed as the weighted arithmetic average of the stability values attached to each sub-link as follows:

$${I}_{rbs} = \frac{94 \times 1.300 + 84 \times 3.400 + 63 \times 5.700 + 98 \times 1.600}{1300 + 3.400 + 5.700 + 1.600} = \frac{923.7}{12} = 76.98$$

The global numerical value of the road body stability index, I_{rbs}=76.98, was entered into the Table 3, row 16, column 23. (250)

It should be noted that the sample homogeneous road section is divided into 4 sub-sections, all homogeneous in relationship to road body stability, having the following lengths: 1.300 km, 3.400 km, 5.700 km and 1.600 km. See deflection diagram in FIG. 32.

Uniform road body stability should be ensured all along any section carrying a uniform amount of traffic.

### 10 Winter Serviceability Index, I_{ws},

I_{ws} is one of the road's operational functions. The ideal situation for this parameter shall be considered that in which the road traffic in winter flows in the same conditions as in summer. Therefore, any decrease in normal serviceability implies a decrease in rating score (210). All homogeneous sections of the network shall be surveyed and assessed by pursuing the following 3 criteria:
Quality of Design, I_{wsd}: road designers are required to locate and design the roads by taking into consideration their susceptibility of being snow drifted. When surveying is performed the quality of design from this perspective shall be checked. This evaluation shall end up with attributing a score on a 0-100 rating scale to each kilometer of each homogeneous section.
Quality of execution, I_{wse}, a score on a 0-100 rating scale shall be attributed to each kilometer of each section, after having been surveyed from the quality of construction perspective.
Quality of maintenance, I_{wsm}, means the assessment of maintenance level that was exerted by maintenance units.

The value of the winter serviceability index, I_{ws}, for each kilometer, shall be computed as an arithmetic mean of the value of all 3 sub-parameters, as follows:

$${I}_{wski} = \frac{{\sum }_{i = 1}^{3} {I}_{wsi}}{3}$$

I_{wski} winter serviceability index, I_{ws}, of the kilometer i of the sample road section
I_{wsi} value of sub-parameter i (i=1-3), for the kilometer i, in question, in relationship to all 3 sub-parameters

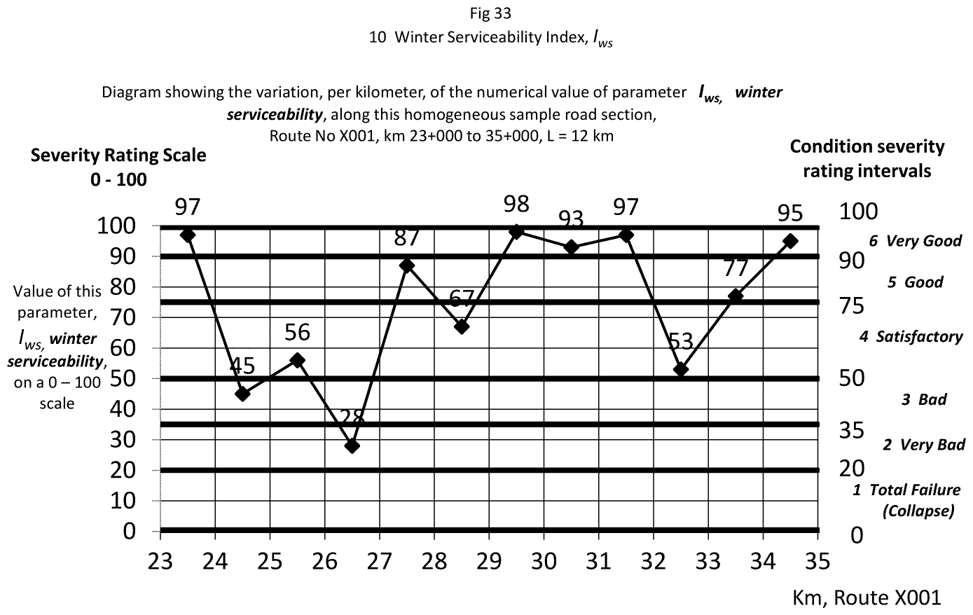

In the numerical example, diagram in FIG. 33 shows the variation of numerical values, per kilometer, of parameter I_{ws}, winter serviceability index, calculated as above, along the sample road section. By using these numbers the value of I_{ws} for the whole sample homogeneous section was calculated as a simple arithmetic mean:

$${I}_{w s} = \frac{97 + 45 + 56 + 28 + 87 + 67 + 98 + 93 + 97 + 53 + 77 + 95}{12} = \frac{893}{12} = 74.42$$

The global numerical value of the winter serviceability index, I_{ws}=74.42, was entered into the Table 3, row 16, column 25. (250)

Instead of dividing (and surveying) the homogeneous sections by kilometer, they can also be divided into homogeneous sub-sections of various other lengths based on uniform or quasi uniform winter serviceability characteristic to distinct sub-sections. Hence, the actual length of the homogeneous sub-sections shall be dictated by the winter serviceability characteristic to such individual sub-sections, and the value of I_{ws} for the whole section in question shall be calculated as a weighted arithmetic mean of the winter serviceability values characteristic to each homogeneous sub-section.

Uniform winter serviceability shall be ensured along any section carrying a uniform amount of traffic.

### 11 Level of Service, Iₗₛ

Iₗₛ is also an operational feature of any road. All homogeneous sections of the network in question could be in very good condition from the perspective of all previous 10 condition parameters, which could have, for example, a value from 90 to 100, but still not satisfactory for the users due to its low level of service. (210)

The concept of level of service used here is the one described in the US TRB's Highway Capacity Manual, in which 6 levels of service are defined, from A to F. Level of service is a major reason of discontent for motorists. When the traffic volumes exceed the road's traffic capacity, in particular from level C down, i.e. D, E and especially F, traffic jams occur, which cause that all budgetary efforts made to raise the value of all the previous parameters to the highest level are annihilated due to low level of service. (210)

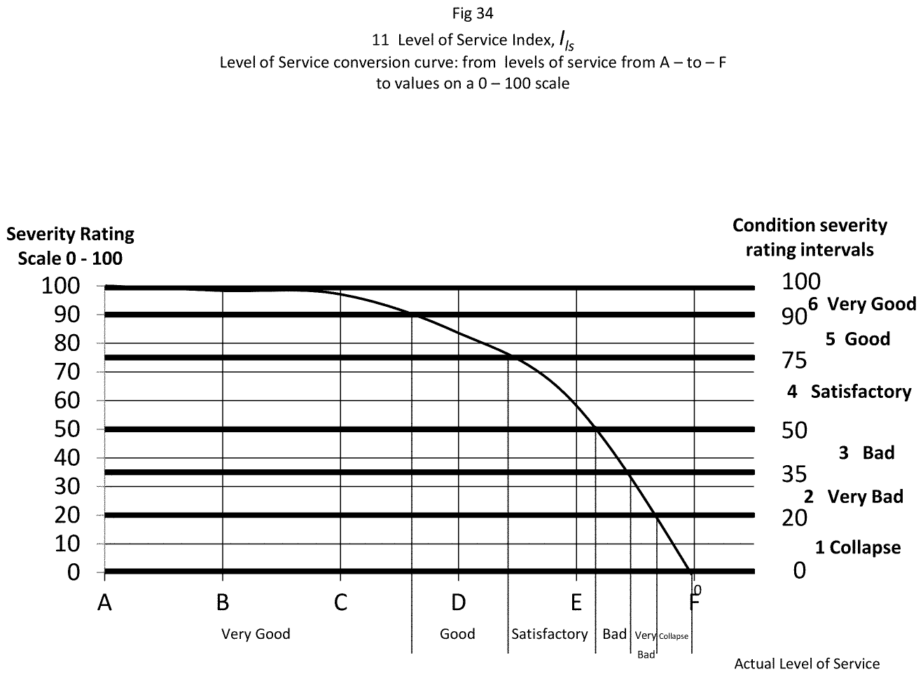

For uniformity purposes, the conversion diagram in FIG. 34 is set for determining the corresponding equivalent value of the actual level of service on a 0-100 rating scale. It comes out from this curve that levels A, B and C are in the area of Very Good, level D is Good, level E is Satisfactory, and beyond level E it is either Bad, or Very Bad or Collapse. (250)

This conversion diagram shows how the numerical value of Iₗₛ, level of service index, decreases very slowly from level A to D, has a value of 50-60 when it is in the E area, i.e. the level that is closest to the traffic capacity of the road section in question, and decreases abruptly towards zero while approaching level F, that is the stagnation level. In spite of any homogeneous section carrying a constant volume of traffic all along its length, the level of service is different along different sub-sections, due mainly to vertical and horizontal geometry, carriageway layout, and other elements. Consequently it is further divided into homogeneous sub-sections, this time in relation to level of service. Dividing a section by way of level of service has nothing to do with the constant traffic volume along that section. In this case the score for this parameter for the whole homogeneous link shall be calculated as a weighted arithmetic mean of the level of service scores assigned to the individual sub-sections which have a constant level of service. (250)

For each section of the network in question, the value of this parameter shall be obtained by computing the weighted average of severity scores as follows:

$${I}_{ls} = \frac{{\sum }_{i = 1}^{n} {s}_{i} {l}_{i}}{{\sum }_{i = 1}^{n} {l}_{i}}$$

Iₗₛ level of service index for the whole homogeneous section in question
sᵢ level of service index, determined by the conversion diagram given in FIG. 34, for sub-section i
lᵢ length of sub-section having level of service index sᵢ
n number of sub-sections homogeneous in relationship to level of service index

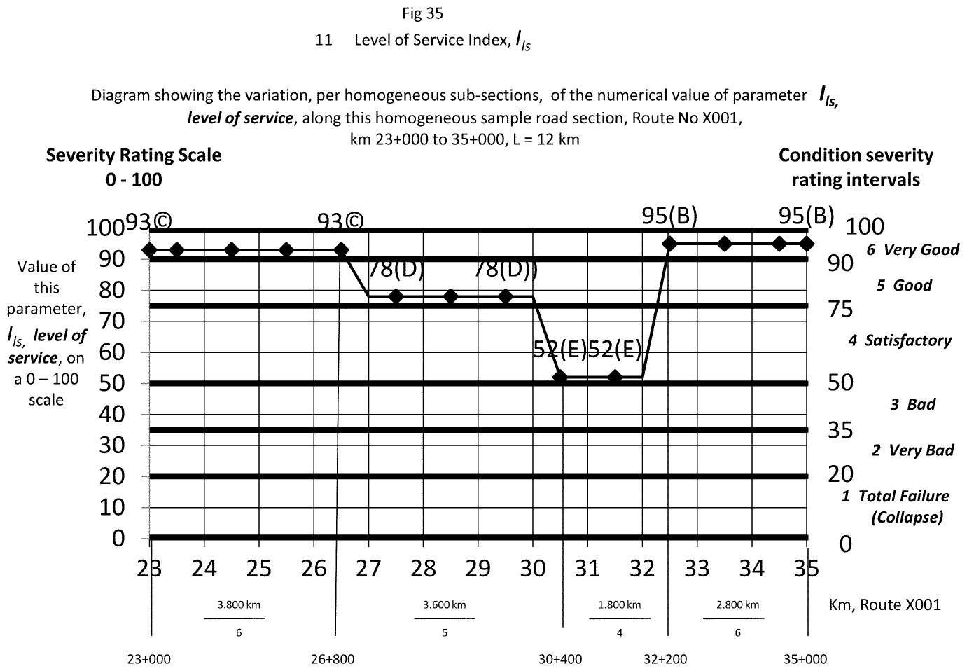

In the numerical example, by using the values from the diagram in FIG. 35, for the sample road section, the weighted arithmetic average of level of service values was computed.

$${I}_{is} = \frac{93 \times 3.800 + 78 \times 3.600 + 52 \times 1.800 + 95 \times 2.800}{3.800 + 3.600 + 1.800 + 2.800} = \frac{353.40 + 280.80 + 93.60 + 266.00}{12.000} = \frac{993.80}{120.00} = 82.82$$

The global numerical value of the level of service, Iₗₛ=82.82, was entered into the Table 3, row 16, column 27. (250)

It should be noted that the sample homogeneous road section is divided into 4 sub-sections, all homogeneous in relationship to level of service, having the following lengths: 3.800 km, 3.600 km, 1.800 km and 2.800 km. See variation diagram in FIG. 35. (250)

Uniform level of service should be ensured all along any section carrying a uniform amount of traffic.

### 12 Environment Protection Index, Iₑₚ,

Iₑₚ refers to how the environment is being dealt with during the whole process of road location, concept design, preliminary and final design, construction, maintenance, operations and any subsequent upgrading. The scope of this parameter is twofold: (1) protection of environment itself: protection of water, air, soil (including erosion control), flora, fauna, cultural heritage, natural landscape, combating construction and traffic noise, and (2) insertion of road alignment into the existing natural environment: that is a harmonious integration into the adjacent natural relief and landscape from the functional, aesthetic and operational perspective. When surveying the network for environment protection evaluation the above elements shall be considered. To evaluate the level of environmental protection, field observations shall be performed. Each homogeneous section shall be surveyed and a score on a 0-100 rating scale shall be attributed to each km of it. (210)

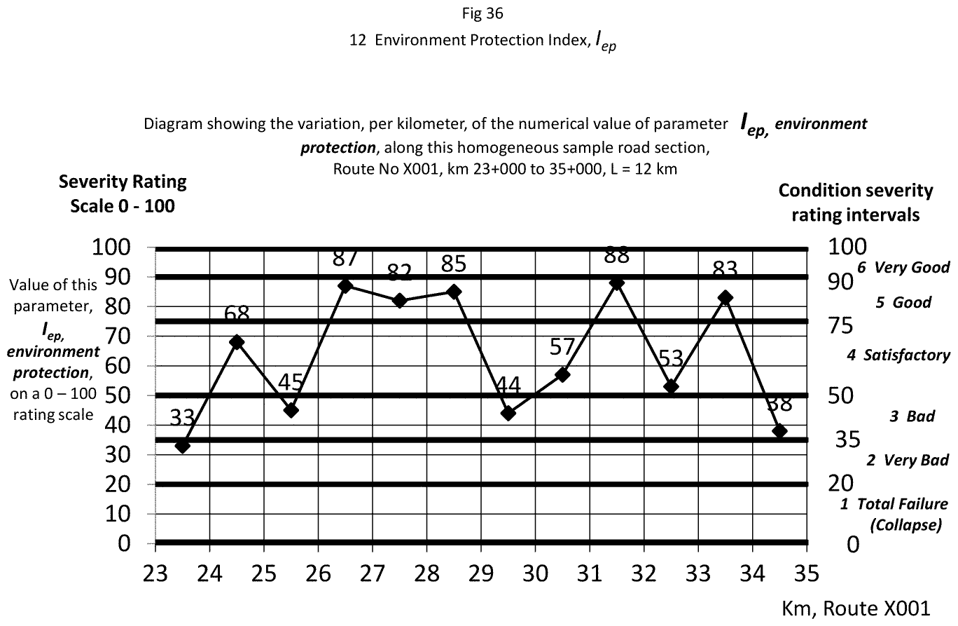

In the numerical example diagram in FIG. 36 shows the variation of numerical values, per kilometer, of parameter Iₑₚ, environment protection index, along the sample road section. By using these numbers the value of Iₑₚ, for the whole homogeneous sub-section was calculated as a simple arithmetic mean:

$${I}_{e p} = \frac{33 + 68 + 45 + 87 + 82 + 85 + 44 + 57 + 88 + 53 + 83 + 38}{12} = \frac{763}{12} = 63.58$$

The global numerical value, Iₑₚ=63.58, was entered into the Table 3, row 16, column 29. (250)

Instead of dividing (and surveying) the homogeneous sections by kilometer, they can also be divided into homogeneous sub-sections of various other lengths based on uniform or quasi uniform environment protection level characteristic to distinct sub-sections. Hence, the actual length of the homogeneous sub-sections shall be dictated by the environment protection level characteristic to individual sub-sections, and the value of Iₑₚ for the whole section in question shall be calculated as a weighted arithmetic mean of the environment protection values characteristic to each homogeneous sub-section.

Uniform environment protection shall be ensured along any section carrying a uniform amount of traffic.

### 13 Quality of Operations Index, I_{qo}

I_{qo} refers to the way the road as an element of transportation infrastructure, is being used. All the above 12 condition parameters could have high scores but, if network operations are not adequately performed network users shall be discontented. In order to accurately assess the value of this parameter each kilometer of each homogeneous section shall be surveyed, the quality of operations during previous years shall be assessed and a score on a 0-100 rating scale shall be attributed to each km. (210)

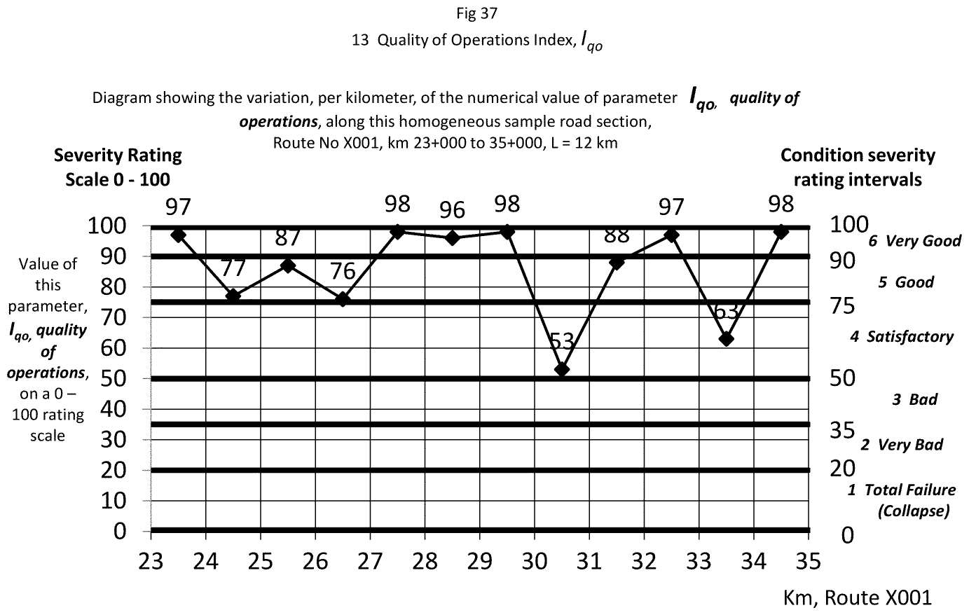

In the numerical example, the diagram in FIG. 37 shows the variation of numerical value per kilometer of parameter I_{qo}, quality of operations index, along the sample road section. By using these numbers the value of I_{qo}, which characterizes the whole sample homogeneous section, was calculated as a simple arithmetic mean as follows:

$${I}_{q o} = \frac{97 + 77 + 87 + 76 + 98 + 96 + 98 + 53 + 88 + 97 + 63 + 98}{12} = \frac{1 \text{,} 028}{12} = 85.67$$

The global numerical value, I_{qo}=85.67, was entered into the Table 3, row 16, column 31. (250)

Instead of dividing (and surveying) the homogeneous sections by kilometer, they can also be divided into homogeneous sub-sections of various other lengths based on uniform or quasi uniform quality of operations characteristic to such distinct sub-sections. Hence, the actual length of the homogeneous sub-sections shall be dictated by the quality of operations characteristic to individual sub-sections, and the value of I_{qo} for the whole section in question shall be calculated as a weighted arithmetic mean of the quality of operations values characteristic to each homogeneous sub-section.

Uniform quality of operations shall be ensured along any section carrying a uniform amount of traffic.

### 14 Quality of Maintenance Index, I_{qm}

Even when all previous 13 condition parameters are situated in the upper area of the severity rating scale, unless the maintenance of the network is appropriately performed the users could still be unsatisfied. In order to accurately assess the value of this parameter, each kilometer of each homogeneous section of the network in question shall be surveyed and the quality of maintenance works performed during the previous year shall be assessed. An appropriate numerical value shall be quantified and assigned to each kilometer. (210)

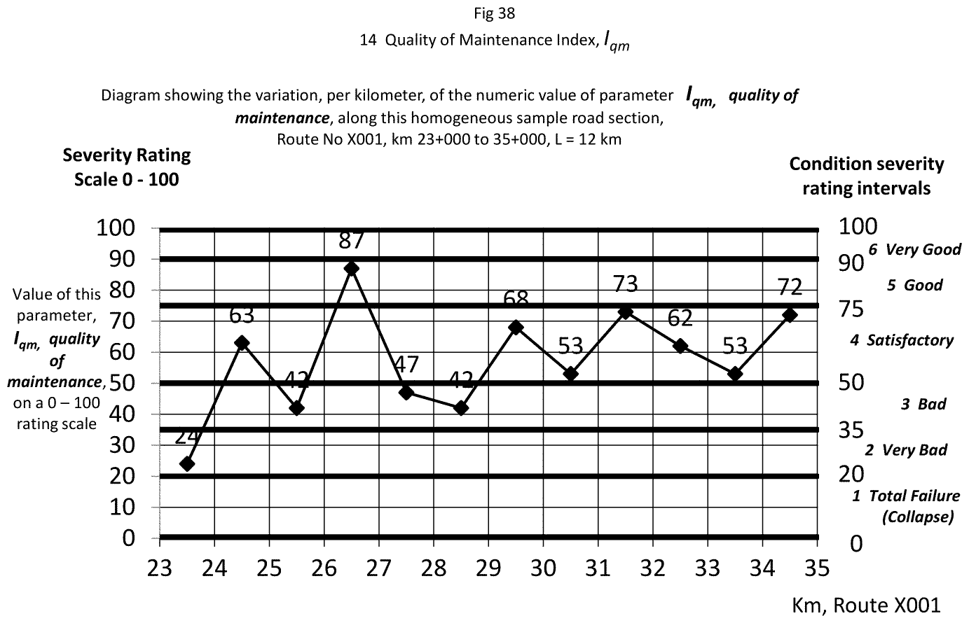

In the numerical example, diagram in FIG. 38 shows the variation of numerical value per kilometer of parameter I_{qm}, quality of maintenance index, along the sample road section. By using these numbers the value of I_{qm}, which characterizes the whole homogeneous sample section from the quality of maintenance perspective, was calculated as a simple arithmetic mean as follows:

$${I}_{q m} = \frac{24 + 63 + 42 + 87 + 47 + 42 + 68 + 53 + 73 + 62 + 53 + 72}{12} = \frac{686}{12} = 57.17$$

The numerical value obtained, I_{qm}=57.17, was entered into the Table 3, row 16, column 33. (250)

Instead of dividing (and surveying) the homogeneous sections by kilometer sub-sections, they can also be divided into homogeneous sub-sections of various other lengths based on uniform or quasi uniform quality of maintenance characteristic to distinct sub-sections. Hence, the actual length of the homogeneous sub-sections shall be dictated by the quality of maintenance characteristic to such individual sub-sections, and the value of I_{qm} for the whole section in question shall be calculated as a weighted arithmetic mean of the quality of maintenance values characteristic to each homogeneous sub-section.

Uniform quality of maintenance shall be ensured along any section carrying a uniform amount of traffic.

The above condition parameters quantification procedures have been applied to all the other 22 homogeneous sections of the sample road network. Thus, numerical values were obtained for all of them and entered in Table 3, in the same manner as for the pilot section. (250)

For the ease of field surveys and measurements the 1.0 km module of length was chosen for the homogeneous sub-sections in some of the condition parameters, but in an actual application this module can be 100 m (or 0.10 km), or 10 m (or 0.01 km), or even smaller, in order to augment the precision of the longitudinal diagrams of condition parameters or sub-parameters.

The optimization of annual budgets by implicitly optimizing the programs of works, for a definite network, shall be performed in two clear-cut stages: Stage I, at road network level and Stage II, at homogeneous section level. (200), (400)

### Stage I: Multicriteria Optimization at Road Network Level

The criteria that the optimization process at the network level is based upon are: (1) technical-operational condition of the network in question; (2) traffic volume criterion; (3) economic development criterion; (4) national defense; (5) social criterion (accessibility, connectivity); and (6) international context. (310)

1 Technical-Operational Criterion. Aggregation of Values of Individual Condition Parameters. Global Serviceability Index, I_{gs}

For each of the homogeneous sections of the network in question a Global Serviceability Index, I_{gs}, shall be calculated once a year, or every time this invention shall be applied, by means of an aggregation formula which takes into account the individual value of all 14 condition parameters. (250), (260)

In the numerical example the numerical values of each of the 14 parameters, and for each homogeneous section of the sample road network, expressed by a score on a 0-100 scale, were quantified and entered in the Table 3. The aggregation of these values in one single value which shall globally characterize each distinct homogeneous section, hence the calculation of a Global Serviceability Index, I_{gs}, is paramount for obtaining a second technically and operationally optimized list of homogeneous sections at network level. (250), (260)

The Global Serviceability Index, I_{gs}, is a function of the individual values of all the 14 condition parameters. Based on the above principles the aggregation of these values shall be done by means of the following simple aggregation formula:

I_{gs}=f(I_{sd},I_{dsc},I_{bc},Iₜₛ,Iᵣᵣ,Iₛᵣ,I_{ga},I_{ngs},I_{rbs},I_{ws},Iₗₛ,Iₑₚ,I_{qo},I_{qm})

or

I_{gs}=a*I_{sd}+b*I_{dsc}+c*I_{bc}+d*Iₜₛ+e*Iᵣᵣ+f*Iₛᵣ+g*I_{ga}+h*I_{ngs}+i*I_{rbs}+j*I_{ws}+j*I_{ws}+k*Iₗₛ+l*Iₑₚ+m*I_{qo}+n*I_{qm}

in which:
I_{gs} is the global serviceability index (to be calculated for each homogeneous section of the network)
a, b, c, d, e, f, g, h, i, j, k, l, m and n, are constant weight coefficients
and
I_{sd}, I_{dsc}, I_{bc}, Iₜₛ, Iᵣᵣ, Iₛᵣ, I_{ga}, I_{ngs}, I_{rbs}, I_{ws}, Iₗₛ, Iₑₚ, I_{qo}, I_{qm} are the 14 technical and operational condition parameters.

Another principle adopted for this aggregation formula is that the sum of the weight constants be equal to 1.00, that is:

a+b+c+d+e+f+g+h+i+j+k+l+m+n=1.00

Each of the 14 parameters shall have a certain weight in the aggregation formula established by the weight constant attached to each condition parameter, which shall reflect its importance in the global aggregation process. Hence, a weight rank was attributed to each of the 14 parameters. The value of weight factors were established following the principle that the higher the priority rank of a parameter the more it should contribute to raising the section concerned to a higher priority position on the optimized list of network's sections; hence, the lower the value of its constant weight coefficient the more it shall determine a decrease of parameter's value on a 0-100 scale, consequently pushing the section in question upward on the optimized list. (250), (260)

Based on the principles formulated above, in its final form the aggregation formula is:

I_{gs}=0.045I_{sd}+0.049I_{dsc}+0.053I_{bc}+0.057Iₜₛ+0.061Iᵣᵣ+0.065Iₛᵣ+0.069I_{ga}+0.073I_{ngs}+0.077I_{rbs}+0.081I_{ws}+0.085Iₗₛ+0.090+Iₑₚ+0.096I_{qo}+0.099I_{qm}

Each of the 14 individual condition parameters for each homogeneous section has a value between 0 and 100; hence the value of the Global Serviceability Index, I_{gs}, calculated by the above formula, given the sum of the constant coefficients being equal to 1.00, shall be also situated between 0 and 100, regardless of their individual value. (250)

In the Table 3 the 23 homogeneous sections appear in their first order of priority in relationship to the traffic volumes in ESALs in their descending order. See column 6. In this table the traffic volumes carried by each of the homogeneous sections are not employed in the aggregation calculation process. They were simply used only for an initial sorting of the network's sections. In the current practice these traffic volumes are to be extracted from the appropriate records of the road administration concerned. They are initially stored as physical vehicles of various categories according to standardization in each country, and then converted into ESALs by specific procedures, to create a common denominator, and entered in column 6. (250)

In the numerical example, tables 1 and 3, the highest number of ESALs, 4,298, is carried by the section on the road link X006, from km 8.490 to km 13.990, i.e. 5.500 km long; and the smallest number is 1,197 ESALs and is carried by a section on link X01B, from km 36.889 to km 65.003, i.e. 28.114 long.

In Table 3, columns 7, 9, 11, 13, 15, 17, 19, 21, 23, 25, 27, 29, 31 and 33 contain the value of each of the 14 condition parameters as they are to be obtained from field surveys, measurements and consequent quantifications. Columns 8, 10, 12, 14, 16, 18, 20, 22, 24, 26, 28, 30, 32 and 34 contain the values of the same 14 parameters as computed by applying the corresponding weight coefficients to their field values. By summing up all these 14 values the aggregated value, or I_{gs}, or Global Serviceability Index, of each homogeneous section is obtained; they are entered in the column 35. All these values are situated within interval 0 and 100. This I_{gs} globally characterizes the homogeneous sections, from the physical and operational condition perspective, at a given moment in time. (250)

Once the global serviceability index, I_{gs}, was calculated for each distinct homogeneous section of the network in question (Table 3), the next step in the network level optimization process is re-sorting the 23 homogeneous sections by the aggregated numerical values of I_{gs}, in their ascending order (260). This is actually the optimization by the first criterion, which is technical-operational. See Table 5. Column 1 shows the new order of the 23 sections, while column 2 shows what became the initial sequence numbering, i.e. the one in a descending order of ESALs per section, after the ascending order of the calculated values of I_{gs} was applied. For example, section X006, km 8.490-13.990, which, initially, by the traffic volume, was on the first place, in this table it became No 23 due to high value of its I_{gs}: i.e. good technical and operational condition, hence lower priority for maintenance and upgrading, regardless the amount of traffic it carries. Also, I_{gs} for the new section No 1 is 41.47 (the smallest of all), it being situated in the severity range 3(35-50), or Bad, on the condition parameter rating scale, and 79.94 (the highest value of all) is for the new section No 23 (i.e. severity interval 5(75-90), or Good, on the rating scale). That is no sections fall in the interval 1 and 2, and no sections fall in interval 6. Columns 9-36, showing the aggregation calculation by the set formula, were maintained for easy reference. (260)

### 2 Re-Optimization by a Combined Criterion: Technical Condition and Traffic

The second criterion of the multi-criteria optimization process at the network level is the traffic volume which each homogeneous section of the road network in question carries. It influences the level of priority of the respective section on the optimized list of sections. For example, if the value of I_{gs} of a section is high, which means the said section is low on the priority list from the technical-operational standpoint, but that section carries a higher amount of traffic, it shall migrate higher on the optimized list. This is taken into consideration by calculating two traffic correction coefficients: C_{dt}, or direct traffic coefficient, and Cᵣₜ, reverse traffic coefficient. (310)

A separate table was designed for this purpose: Table 6. It shows the same sequence numbering as in Table 5, i.e. columns 1 to 8 are maintained. In column 9 the direct traffic correction coefficient was calculated by proportionally relating the traffic volume carried by each section to the highest number of ESALs carried by one of the network's sections, which, in this case is 4,298 ESALs. It was assigned the score 100. Thus: C_{dt}=(i×100): 4,298, where i is the traffic volume carried by each of the other 22 sections (1-22). In column 10 the reverse traffic correction coefficients were calculated by deducting the values in column 9 from 100 so giving them the logical sense, that is the higher the amount of traffic the smaller the traffic coefficient and, hence, the higher the rank of the respective section on the optimized list. In column 11 the two coefficients, I_{gs} (technical) and Cᵣₜ (traffic) are added together to obtain the composite coefficient, i.e. technical index (physical-operational condition) and traffic index. Most of these values are higher than 100. In column 12 the values of the Composite Coefficient are brought into a 0-100 scale, again by proportionally relating the composite coefficient in column 11 to the highest value of it which in this case is 149.6247 (of the section No 21 in this table). It was also assigned the score 100 for this purpose. (310)

Consequently, the role which the traffic volumes have in optimizing the list of homogeneous sections, hence at the network level, is only made evident by its combining with the technical criterion.

On the basis of the composite coefficient values (I_{gs}+Cᵣₜ), as brought into a 0-100 scale (shown in Table 6, column 12), a third sorting of the 23 sections was performed, this time by the ascending values of the Composite Coefficient as calculated in column 12 of Table 6. See column 1 of the Table 7 (310). The previous two orderings have changed accordingly and are shown in columns 2 and 3 as they became after this third sorting. Data in columns 4-12 in this table are the same as in previous table only reordered accordingly. Column 13 shows the values of the Composite Coefficient, brought into a 0-100 value scale by proportionality (see Table 6, column 12) but arranged here in an ascending order.

The composite coefficient, I_{gs}+Cᵣₜ, column 13, is used here as an instrument for bi-criteria optimization, technical and traffic. (310)

### Economic Development Criterion.

This is the 3^{rd} optimization criterion at network level. No matter how important the previous 2 criteria are, if in the general economic development plan of the region concerned, a certain area becomes a priority from this perspective, and a certain number of sections of that network should be upgraded to higher standards of level of service, bearing capacity, traffic safety etc, then these sections are raised higher on the optimized list of homogeneous sections, regardless their physical-operational condition and the traffic volume they carry, and a re-optimization is performed from this standpoint. (310)

### Strategic Defense Criterion.

Based on the same rationale as described above, the optimized list of homogeneous sections can undergo modifications on defense strategies grounds. (310)

### 5 Social—Cultural Criterion

is applied when upgrading of certain road sections are necessary, as a rule, local roads, so that a better accessibility and connectivity to the public roads network be created to a locality or a group of localities, even if the respective sections do not carry large amounts of traffic or their technical condition is not bad. (310)

### 6 International Context Criterion

exists in case of countries of some regions of the world in which the international context is important for certain road sections. This implies the continuation of some international traffic arteries, which can modify the optimization by the other criteria. (310)

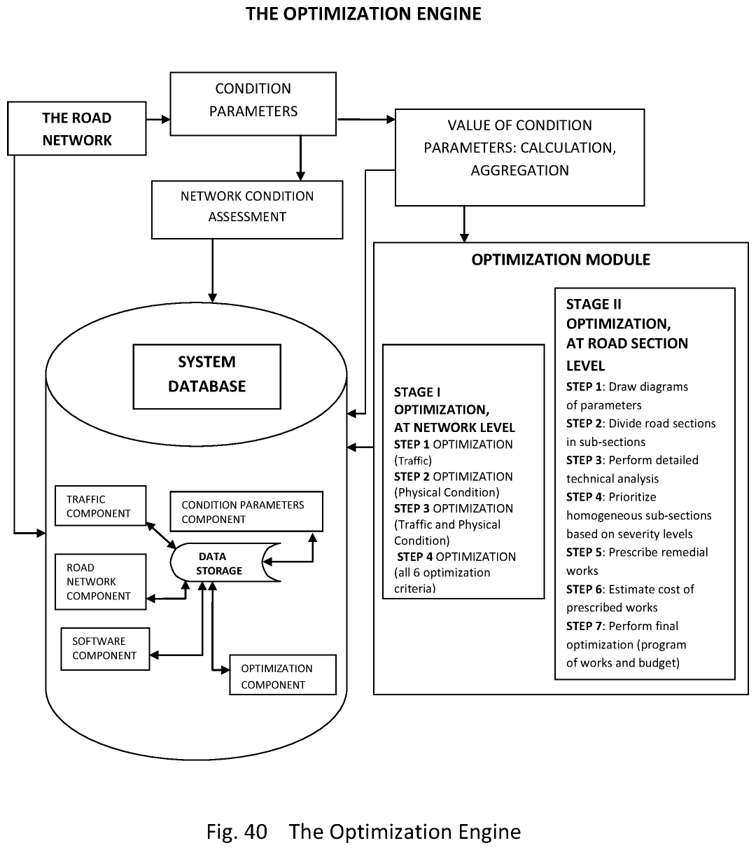

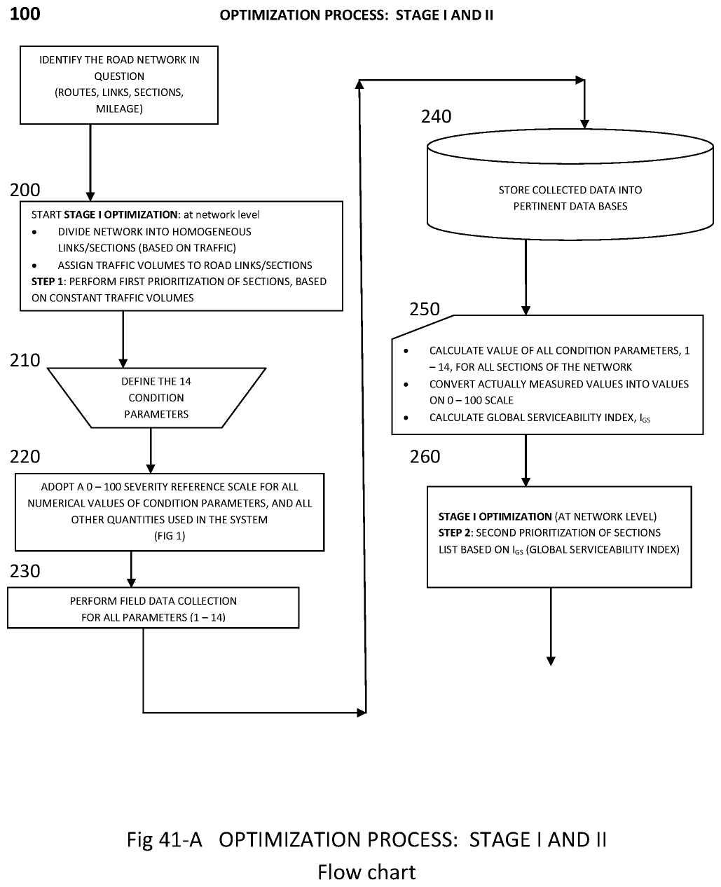

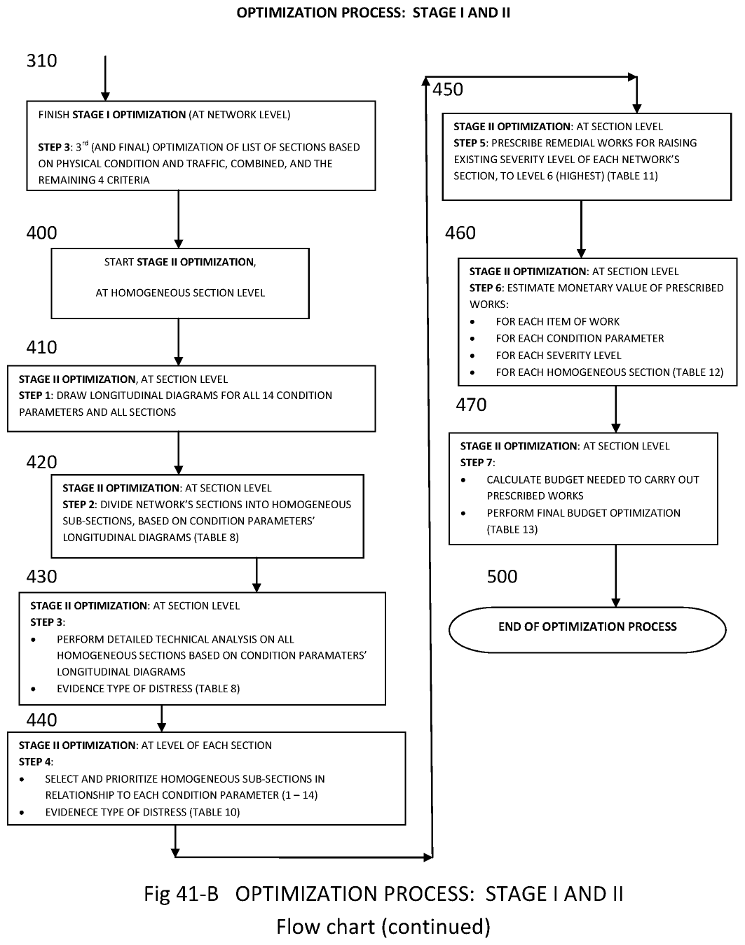

The sequence numbering of the homogeneous sections as shown in column 1 of the Table 7 is the final one based on criteria 1 to 6; it shall be used in Stage II optimization, at the homogeneous section level. Actually, no changes were made here consequent to criteria 3, 4, 5 and 6. See also FIG. 40—The Optimization Engine, and FIG. 41A and FIG. 41B, the flowchart for the whole optimization process.

### Stage II Optimization: At the Level of Individual Homogeneous Sections

Stage I optimization, i.e. at network level, does not directly generate road works projects that should be performed in order that the sections situated in the upper part of the optimized list be rehabilitated or upgraded; thus, the optimization process should continue into its second stage, that is the optimization at the level of homogeneous sections. (400)

In the context of this detailed description the terms maintenance and rehabilitation are similar and mean either keeping the road condition, as much as possible, at the level it was at the completion of the latest major upgrading on that particular section, or bringing it back to that condition by rehabilitation, while upgrading means raising the overall physical and operational condition of the same section, from the current status to a higher level, to cope with ever growing traffic demands.

The application of this invention to the level of an individual homogeneous section implies an extremely detailed technical analysis of each such section from the perspective of each condition parameter, so that the annual program of road rehabilitation and upgrading works and, implicitly, the corresponding annual budget of the administration concerned, covers only and only the works that are mostly needed by each homogeneous section and sub-section of the network in their strict order of priority, for raising the existing rating level to level 6(90-100), or Very Good. (430)

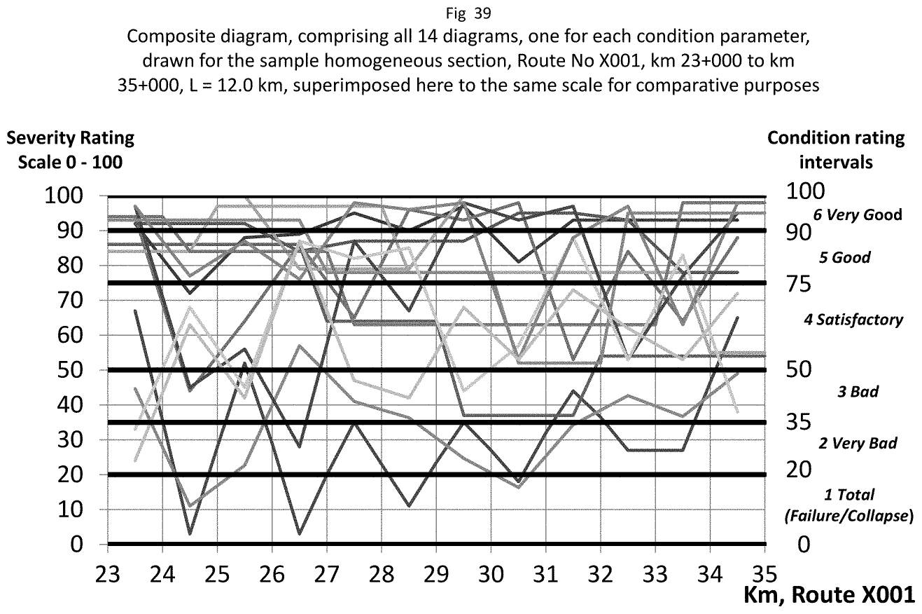

The following steps form the basis of the detailed technical analysis, as part of the entire optimization process at the level of individual sections:
For each homogeneous section of the network in question and for each of the 14 condition parameters, a diagram showing the variation of the value of respective parameter along the homogeneous section shall be drawn, as exemplified for the pilot section, on the basis of field surveys and measurements, and back-to-office quantification of values. (410)
On the basis of these diagrams each homogeneous section shall be further divided into sub-sections of various lengths, in relationship to each condition parameter, 1-14, separately, called also homogeneous sub-sections, i.e. sub-sections along which the respective condition parameter is constant or quasi constant; consequently, no matter what length of the section they characterize, they fall within one of the 6 condition severity intervals. See FIG. 1 and Table 8, columns 5, 6, 8, 10 and 14. (420)
The detailed technical analysis shall be performed for each homogeneous section individually, by comparatively examining the diagrams of longitudinal variation of the value of each of the 14 condition parameters, by their juxtaposition or superimposition to scale (430). See example in FIG. 39 for superimposition of diagrams. The detailed technical analysis of each homogeneous section shall be done strictly in the order they were listed at the end of the multi criteria optimization, Stage I Optimization, at network level, as in Table 7, column 1. See also Table 8, columns 1 and 6.

FIG. 39 gives a rough idea about the general condition of each homogeneous section. It shows how the 14 longitudinal condition diagrams are distributed vertically, where they are concentrated the most, and tells which is/are the predominant parameter/s, so that attention can be concentrated upon those parameters showing the worst severity rating. The actual comparative analysis shall be done by juxtaposing the 14 diagrams. (430)

This detailed technical analysis is the most important component of the Stage II optimization. Fundamentally, the 2^{nd} stage optimization is based on a series of tables. See Tables 8, 9, 10, 11, 12 and 13.

The sub-sections which fall in each of the 6 levels of condition severity with specific severity scores become evident from the Table 8, columns 8, 10 and 14 (430). In the numerical example the diagrams were drawn for the pilot homogeneous section only. See FIGS. 2-23, 25, 27, 29-33 and 35-38.

On the diagrams, the numerical values, from 0(zero) to 100, shall be shown on the ordinate (y axis); the horizontal lines evidencing the border between the 6 consecutive condition severity intervals (1 (0-20), or Collapse; 2(20-35), or Very Bad; 3(35-50), or Bad; 4(50-75), or Satisfactory; 5(75-90), or Good; and 6(90-100), or Very Good), shall also be drawn. This will show in which of the 6 condition severity intervals each numerical value along the diagram of each condition parameter falls. (420)

In the case of parameters divided into 2 or more sub-parameters, a longitudinal diagram shall be drawn for each of them: see the pilot section, I_{sd}, or Surface Distress, and I_{dsc}, or Drainage System Condition, and others. (420)

In the numerical example, and for all the 23 individual sections which compose the sample road network, this was done in the Table 8; in column 1, the 23 sections appear in the sequence established during the first optimization stage (Table 7, column 1 and 13). (430)

In column 6 of Table 8, the value of the Composite Coefficient assigned to each section (as in Table 7, column 13) is shown; it determined the final sequence numbering of the 23 sections at the end of the Stage I Prioritization. In column 8, all the 14 condition parameters, in their order of importance, are entered for each of the 23 sections. Column 10 shows the number of homogeneous sub-sections in which each section is divided in relationship to each respective condition parameter and to all severity rating levels, on the basis of the longitudinal diagrams drawn for each section and for each condition parameter (430). In all, for the pilot network, there are 322 diagrams and 677 homogeneous sub-sections in respect to each and all 14 condition parameters. The length of each of these sub-sections, in relation to each condition parameter (1-14) and each rating level in which they fall, is also shown in column 13. Column 14 shows the severity rating level in which each homogeneous sub-section falls.

The 14 diagrams, one for each condition parameter, drawn for the pilot section, are shown in FIGS. 18, 22, 23, 25, 27, 29-33, and 35-38 (420). They show how this section is divided into homogeneous sub-sections in relation to each condition parameter and each rating level in which they fall, that is 11 for 1(I_{sd}), 9 for 2(I_{dsc}), 4 for 3(I_{bc}), 6 for 4(Iₜₛ), 10 for 5(Iᵣᵣ), 4 for 6(Isr), 4 for 7(I_{ga}), 3 for 8(I_{ngs}), 4 for 9(I_{rbs}), 10 for 10(I_{ws}), 4 for 11(Iₗₛ), 10 for 12(Iₑₚ), 8 for 13(I_{qo}) and 6 for 14(I_{qm}). This shows how highly non-homogeneous that road section was at the time this method is applied for the first time. (430). Each condition parameter varies in its own way along a road section.

The 14 diagrams, if juxtaposed, allow for a comparative analysis of the whole section in question, and the main deficiencies of the said section can be identified as predominant parameters, regardless the length of the respective sub-section. The predominant parameters shall be those which are paramount for the physical condition of the road, e.g. Bearing Capacity of Road Body, or I_{bc}, Road Surface Roughness, or Iᵣᵣ, Geometric Adequacy, I_{ga}, Natural Ground and/or Road Body Stability, etc, and fall in the lowest severity intervals. (430)

The (predominant) type of work which shall be prescribed and executed, shall concomitantly resolve a certain number of the other problems existing along its length, pertaining to other parameters. For those problems which it does not solve, other, specific types of work shall be prescribed. For the remaining portions of the homogeneous section concerned, not covered by the predominant parameter, specific types of work shall also be prescribed for their resolution, i.e. bringing the whole section up to the severity level 6(90-100) from the standpoint of all 14 parameters (440). A 2^{nd} and/or a 3^{rd} predominant parameter can also be identified from the 14 diagrams. By accurately and correctly prescribing the remedial works even the smallest waste of funds shall be avoided. (440)

The issue of program of works and budget optimization in the manner described herein can be tackled in 3 different ways: either (1) by focusing the optimization process on severity levels, that is to raise them all from existing level to level 6(90-100), or Very Good, one by one from 1 to 5, in all condition parameters and all sections, or (2) on condition parameters, that is to raise their existing values to level 6(90-100), or Very Good, one by one from 1 to 14, for all sections, level by level, or (3) on homogeneous sections, i.e. to raise the value of all condition parameters, 1-14, from their existing severity levels to level 6(90-100), in each of them, one by one, from 1 to 23.

For the numerical example the third option was applied, as a preferred embodiment, i.e. the optimization process is focused on each of the 23 sections in their order of priority, one by one, all condition parameters having been dealt with, within each severity level, 1-6, one by one. Table 9, is a simplified version of Table 8, of which columns 6, 7 and 9 were eliminated. In Table 10, a selection of all homogeneous sub-sections, in relationship to all condition parameters which fall in the severity interval 1 (0-20, collapse), was made from each of the 23 homogeneous sections, one by one, in their order established in Stage 1, hence from all the 322 longitudinal variation diagrams and all 677 sub-sections. They were concentrated in one block in the upper part of said table (440). A similar selection was done for the sub-sections which fall in the severity rating interval 2 (20-35, or Very Bad), and for the sub-sections falling in the severity intervals 3, 4, 5 and 6, also from each of the 23 homogeneous sections (440). Table 10 is self explanatory in this respect.

Column 10 of this table indicates that out of the total of 677 such homogeneous sub-sections, 54 fall in the severity interval 1(0-20), or Collapse, 83 fall in severity interval 2(20-35), or Very Bad, 104 fall in interval 3(35-50), or Bad, 162 fall in interval 4(50-75), or Satisfactory, 137 fall in interval 5(75-90), or Good, and 137 fall in interval 6(90-100), or Very Good. (440)

Under section No 1, at the top of this Table 10, sub-sections having severity 1 and 2, do not appear because none of its homogeneous sub-sections, in relationship to none of the 14 condition parameters fall in the rating interval 1 and 2. The same applies to sections 13, 15, 19, 21 and 22. A similar reasoning is applied to the portion of this list which refers to rating level 2, 3, 4 and 5.

The quintessence of the detailed analysis is shown in the Table 11 (450). The overall condition of each section, 1-23, in relationship to all condition parameters, 1-14, and by each severity level, 1-6, is described, the major deficiencies being highlighted. See Column 12. The works proposed for raising the existing severity rating to Level 6(90-100), or Very Good, are described in column 13. (450)

The 677 homogeneous sub-sections coming from the segmentation of the 23 sections of the pilot network are all different as regards their individual length. Moreover, in any section, the segmentation in relationship to any condition parameter does not superimpose over the segmentation done in respect to other condition parameters, except incidentally.

Remedial works are not prescribed for each sub-section of each section, in respect to each condition parameter, which falls in any rating level 1, 2, 3, 4 and 5, because the major works prescribed for raising the value of the predominant condition parameters, e.g. bearing capacity of road body, road surface roughness, geometric adequacy, level of service, etc, implicitly remedy some of the other parameters on the respective sub-section, concomitantly raising their rating score. Therefore, during the detailed technical analysis which shall be made for establishing what works should be executed and where, the above principle will be taken into account so that only those works strictly needed to rehabilitate and upgrade the whole section from the perspective of all 14 parameters shall be proposed, so eliminating the redundant works. Hence, all sub-sections of all sections, no matter the parameter they are related to, once remedied, the value of their I_{gs} shall automatically go to severity level 6(90-100), or Very Good. (450)

The detailed technical analysis described above is the tool by which it is established what works should be executed on the network concerned, and where, and when to be executed, that is the right location and the right timing. (450)

The road works prioritization process is integrated, that is it includes equally all types of work needed to raise the Global Serviceability Index of each homogeneous section to level 6(90-100): i.e. maintenance, repair, rehabilitation, upgrading works, for all 14 condition parameters.

The next step along the Stage 2 optimization process shall establish the precise items of work proposed to be executed on each homogeneous section for raising the rating level of each condition parameter from its current level to level 6(90-100), or Very Good. In the numerical example, in order to illustrate how, in the end, this invention will practically serve the road administrators, in Table 12, columns 9, 10, 11 and 12 show, also, the Unit of Measurement, the quantity, and, for exemplification, the Unit Cost and the estimated monetary value of each proposed item of work. Column 13 of this table shows the total monetary value estimated for upgrading to level 6 each condition parameter, while column 14 indicates the cumulated monetary value of works for raising to level 6 each Severity Rating Level of each of the 23 homogeneous sections. Column 15 shows the cumulated estimated monetary value needed for raising the rating level of each homogeneous section to level 6(90-100). (460)

Further, Table 13 shows, in a more concentrated form, what the Table 12 illustrated in detail. Column 10 indicates the estimated monetary value for works prescribed for each homogeneous section, cumulated for all the Severity Rating Levels of the respective section. Column 11 shows the estimated monetary value for works prescribed for each homogeneous section of the pilot road network, cumulated section by section to gradually reach the budget needed for the whole network. (470)

Again, in terms of practical effects, the numerical example shows that the whole amount needed to bring the value of all the condition parameters in all the 23 homogeneous sections that fall in the severity rating intervals 1, 2, 3, 4 and 5, up to the level 6, is US$254,679,435.49 (470). This is the amount that the respective road administration should obtain from the pertinent authorities to achieve the above goal; depending on the size of the budgetary funds made available, the administration concerned shall go down the column 11 of this table to the number closest to the magnitude of the budget allocated. If the amount made available by the pertinent decision makers is smaller than the total amount needed to raise the rating level of all 23 sections to 6(90-100), for all 14 parameters, then the administration shall have to rehabilitate and upgrade as many of the 23 homogeneous sections of the respective network, as can be covered by the budget made available. The table allows for an extension of the program of works in case a subsequent budget supplementation takes place. (470)

The amount resulted for each of the 23 sections composing the pilot network shall cover all the works needed to raise the Severity Rating Level, in all 14 parameters, from the existing one, which could be anywhere from 1 to 5, to level 6(90-100), or Very Good. (470), (500)

After having been rehabilitated or upgraded, by the first application of this invention, the sections which are located at the top of the optimized list, once their I_{gs} was augmented to level 6, during the following application of this invention they will leave the top of the list and migrate to the bottom of the optimized list of sections, while other sections which have a lesser technical-operational condition will migrate gradually towards the upper part of the list. This is the dynamics determined by this invention within a distinct road network: a continuous migration of homogeneous sections from the bottom to the top of the optimized list, as their physical and operational condition degrades, or if they carry a higher amount of traffic.

The estimates presented in Table 12 are based on preliminary, rough assessment of quantities for each item of work; unit costs are those generally accepted on the market for these units of measurement. After the budget shall have been approved the road administration concerned shall perform the final design for the individual projects specified, hence more precise estimates shall be obtained for use in contract awarding process, which could be smaller or bigger. Actually, during the design process the last step of the optimization process (at section level) shall take place given the designer's possibility to adopt the most technically and economically convenient design solution for each given maintenance, rehabilitation and/or upgrading project.

The multi criteria optimization of road administrations' program of works and budget by means of the method described here should be performed each year regardless the network's pace of deterioration, i.e. even if the condition of the network in question did not deteriorate dramatically from one year to another. Thus, the rate of the network's condition deterioration shall be kept under surveillance, the expenses accruing from its application should normally decrease each year and the effect of applying this invention upon the annual dynamics of the budget in correlation with the ever improving the overall condition of the network in question shall be traced.

A separate section shall be created in the pertinent road data base of the administration concerned, for storing all the data collected and used along the application process, thus creating historical data for subsequent analyses (240). Given the tremendous amount of data which should be collected from the field and further stored and processed, as well as the complexity of this system, a specific computer program shall have to be written in order to keep the application time wise within reasonable limits. See also FIG. 40—The Optimization Engine, and FIG. 41A and FIG. 41B, the flowchart for the whole optimization process.

When focusing on homogeneous sections, the optimization process shall be extended to all first 5 rating levels, 1-5, the goal being level 6. Nevertheless, the pertinent authorities may choose to set a different rating level as an annual target, for the sake of covering a larger portion of their network, but with raising its existing condition to a rating level lower than 6. Under such circumstances, the remedial works for the deficiencies specific to the higher levels will be postponed for the following years.

Similarly, when focusing the optimization process on severity levels, the pertinent road authority may choose to make good either 1, or 2, or 3 severity levels, for all parameters and all sections, by raising them to level 4, or 5, or 6, depending on the funds available. The same policy can apply when focusing the optimization on condition parameters.

Also, the authorities may set the level of serviceability of a self-contained road network, as a function of its importance as compared with other networks of the country in question; e.g. county roads are of a less importance than national roads.

1. (canceled)

2-16. (canceled)

17. (canceled)

18. (canceled)

19. (canceled)

20. A method for a global, multi criteria, multi-level and multistage optimization of programs of works and budgets in public roads administrations comprising the steps of:
performing Stage One Optimization at road network level;
performing Stage Two Optimization at road section level;
carrying out the optimization of budget at network level.

21. The method according to claim 20, wherein said step of performing Stage One Optimization at road network level further comprises the steps of:
dividing the road network in question into homogeneous sections based on the constant traffic volume they carry;
assigning the constant traffic volumes to the homogeneous sections;
performing the first prioritization of the list of road sections based on traffic volumes assigned to them;
defining the suite of fourteen condition parameters, i.e. (1) Road Surface Distress, I_{sd}, (2) Drainage System Condition, I_{dsc}, (3) Bearing Capacity of Road Body, I_{bc}, (4) Traffic Safety Level, Iₜₛ, (5) Road Surface Roughness, I_{dsc}, (6) Skid Resistance, Iₛᵣ, (7) Geometric Adequacy Index, I_{ga}, (8) Natural Ground Stability Index, I_{ngs}, (9) Road Body Stability Index, I_{rbs}, (10) Winter Serviceability Index, I_{ws}, (11) Level of Service Index, Iₗₛ, (12) Environment Protection Index, Iₑₚ, (13) Quality of Operations Index, I_{qo}, (14) Quality of Maintenance Index, I_{qm}; establishing the road condition severity rating scale, 0-100, as a uniform reference system for the values of condition parameters and all other quantities used in present optimization system;
establishing specific, standard procedures for measuring and quantifying the values of the fourteen condition parameters;
quantifying the values of all fourteen condition parameters, for all sections of the network;
converting actually measured deflections, roughness, and skid resistance, and actual traffic levels of service, into values situated within a 0-100 severity rating scale;
establishing a series of 6 optimization criteria for the Stage I Optimization, at the network level, i.e. technical-operational condition of the network in question; traffic volume criterion;
economic development criterion; national defense criterion; social criterion (accessibility, connectivity); and international context;
calculating a Global Serviceability Index, or I_{gs}, for each distinct homogeneous section of the road network in question, by a specific aggregation formula, expressed by a score on a 0-100 scale;
producing a second optimized list of sections of the road network in question, in relationship to the Global Serviceability Index, I_{gs}, in its ascending order;
performing a third, and last, optimization of the list of sections of the road network in question, in relationship to both criteria, physical and operational condition and traffic volume, combined.

22. The method according to claim 20 wherein the said step of performing Stage Two Optimization of program of works at road sections level further comprises the steps of:
drawing longitudinal diagrams for all 14 condition parameters and all sections of the road network;
dividing all road sections into homogeneous sub-sections based on the longitudinal variation of condition parameters;
carrying out the detailed technical analysis on all road sections;
prioritizing homogeneous sub-sections in relationship to each condition parameter;
prescribing remedial works for all sections;
producing the optimized program of works.

23. The method according to claim 20 wherein the said step of carrying out the optimization of budget at network level further comprises the steps of:
estimating monetary value of prescribed works for each section of the network;
calculating the budget needed to carry out prescribed works;
performing final budget optimization for the entire network by cumulating the budgets needed for each section.
